(19) United States
(12) Patent Application Publication
(10) Pub. No.: US 2026/0232522 A1
(43) Pub. Date: Aug. 13, 2026

(54) DRY MASSAGE APPARATUS

(71) Applicant: JK-HOLDING GMBH, Windhagen (DE)

(72) Inventor: Jürgen GERSTENMEIER, Neuwied (DE)

(73) Assignee: JK-HOLDING GMBH, Windhagen (DE)

(21) Appl. No.: 19/153,681

(22) PCT Filed: Mar. 20, 2023
(86) PCT No.: PCT/IB2024/052544

§ 371 Date: Aug. 5, 2025

(30) Foreign Application Priority Data
Mar. 20, 2023 (CH) 000307/2023
Mar. 20, 2023 (CH) 000308/2023

(51) Int. Cl. A61H 9/00

(52) U.S. Cl. CPC A61H 9/0021; A61H 2201/1238; A61H 2201/5051

(57) ABSTRACT

A dry hydromassage massage apparatus comprises a basic structure; and a massage module comprising a substantially closed container having a wall; a flexible membrane forming part of the wall of the closed container, having a first surface towards the interior of the closed container; and at least one massage nozzle device arranged to direct a liquid jet onto the first surface of the flexible membrane inside the closed container. The massage apparatus has a drive module which is arranged to move the massage module in relation to the basic structure in at least one direction of movement.

### FIELD OF THE INVENTION

The invention relates to massage apparatuses for hydromassage, in particular dry hydromassage, and to a massage nozzle device for generating a directed liquid jet.

### TECHNOLOGICAL BACKGROUND

Bathtubs with a massage function and similar devices for so-called hydromassage are known, in which the user's body is immersed in water and one or more water jets direct a jet of water onto the body, which exerts a mechanical force on the corresponding part of the body when it hits it. Such water jet massage devices require a lot of space and energy and are heavy. As the user has to be in the water during the massage, the use of such massage apparatus is time-consuming. In addition, there are complex maintenance requirements, particularly for hygienic reasons.

Massage tables and massage chairs that can massage a user automatically using mechanical massage elements are also known. In such massage apparatus, electrically driven mechanical actuators exert a limited localized force on the user's body. The mechanical actuators are built into a reclining surface or backrest, for example. In order to achieve a massage effect on different parts of the body, a number of actuators are required. Mechanical actuators are expensive to manufacture and maintain. They are susceptible to wear and tear due to the moving mechanical components. The usually hard massage heads regularly lead to an unpleasant massage sensation or even pain due to the resulting force.

CN 203280724 U shows a device for “dry” massage by means of water jets, also known as dry hydromassage, in which a large number of upwardly directed water jets are permanently arranged in a tub filled with water. The top of the tub is sealed watertight with a flexible membrane. The user to be massaged lies on the membrane. The water nozzles each eject a directed jet of water that hits the underside of the membrane at a predetermined point. A force is exerted on the user's body via the flexible membrane to achieve the desired massage effect. The large number of water jets makes such a massage nozzle device expensive to manufacture and operate.

EP 0880958 A1 describes another apparatus for dry water jet massage. A user lies in a water-filled tub, which is closed at one upper end by a flexible, waterproof membrane, as if on a waterbed. One or two longitudinally movable nozzle slides are arranged at the bottom of the tub. Two massage nozzles are arranged on the nozzle slides, the distance between which can be adjusted in a transverse direction. A pump pumps water through the nozzles so that a directed jet of water is produced in the direction of the flexible membrane. Similar devices are also known from EP 1666017 A1 and EP 2327386 A1.

From US 2022/0323287 A1 of the applicant, the disclosure of which is hereby incorporated in its entirety by reference into the description, a further device for dry massage by means of water jets is known. Shown is a device for dry water jet massage with a tub which is filled with water and a foil material which simultaneously serves as a lying surface for a person to be treated and enables pressure pulse transmission. This serves as a cover that seals the top of the tub watertight. A carriage with at least two water nozzles is arranged in the tub, whereby the water nozzles each serve to eject a water jet against the underside of the foil material. The water nozzles are fed by a pump. A first drive is used to move the trolley forwards and backwards in the longitudinal direction of the tub. A second drive moves the water nozzles on the trolley in the transverse direction of the tub. The water jets can be swiveled from a rest position to an operating position by means of a lever mechanism.

Massage apparatus of the aforementioned type require a lot of floor space, as they are only intended for use in a lying position. In addition, a lying position during the massage, especially in public spaces, is often perceived as uncomfortable by users, which can impair the relaxing effect of the massage.

JP H6/205811 discloses a massage chair for dry water jet massage. A flexible, water-proof membrane is provided as a seat surface of the S-shaped chair. A guide rail is provided below the seat surface at a constant distance from the membrane. A nozzle carriage is arranged on the guide rail, on which a water nozzle is arranged at a constant distance from the membrane and with an effective axis that is always perpendicular to the membrane. The water nozzle produces a jet of water that moves through the air and generates a force acting vertically outwards at the point of impact on the membrane, which causes the massage. The flexible membrane creates a watertight seal in a housing under the massage chair so that the water from the massage nozzles remains inside the device and can be collected at the bottom and pumped out for reuse.

US 2009/0312680 A1 shows a massage chair for dry water jet massage, in which several water nozzles are arranged horizontally on a carriage that can be moved in the longitudinal direction of the backrest. Deflection elements shape the water jets generated by the water nozzles into collective jets directed at specific points on the flexible membrane. The water from the massage nozzles that bounces off the membrane is collected on the floor and pumped out for reuse.

U.S. Pat. No. 5,827,206 shows a massage chair for dry water jet massage, with a flexible membrane as the backrest. Several water jets are fixedly arranged behind the backrest and generate water jets which exert a force on the flexible backrest in order to achieve the massage effect. The water bouncing off the flexible backrest is collected in a pump sump located below the seat surface and pumped back to the water jets in a circuit. US 2009/0312680 A1 shows such a massage chair in which several water nozzles are arranged horizontally on a carriage that can be moved in the longitudinal direction of the backrest. Deflection elements shape the water jets generated by the water nozzles into collecting jets directed at specific points on the flexible membrane.

Massage apparatus of the aforementioned type are noisy, as the water jet is atomized when it hits the backrest. The necessary pump sump requires a lot of volume underneath the seat.

U.S. Pat. No. 6,036,663 describes a water jet massage chair in which a water-filled bladder made of a flexible membrane is arranged on a slope to form the backrest. Permanently mounted water nozzles generate directed water jets which are aimed at the outer side of the membrane bladder and create a massage effect there. Crossbars keep the bladder in shape, as otherwise the water pressure would cause the lower part of the bladder to bulge. The backrest is divided into individual sections accordingly. KR 20110129315 shows a similar device in which the water nozzles are movably arranged on a movable nozzle carriage.

There is a general need for improvements in this area.

### SUMMARY OF THE INVENTION

It is an object the invention to provide a massage apparatus of the type mentioned at the beginning, which counteracts at least one of the above-mentioned disadvantages and other disadvantages.

A massage apparatus according to the invention should combine the advantages of dry and wet massage. In particular, a massage apparatus according to the invention should be able to achieve a similarly high massage effect as a conventional massage with a water jet, while at the same time being the size and user-friendliness of a mechanical massage apparatus.

In particular, it should be possible to massage a seated position with a massage apparatus according to the invention.

Such a massage apparatus according to the invention should be able to be operated in an energy-saving manner.

A massage apparatus according to the invention should be reliable in operation. It should be inexpensive to manufacture and maintain. The required room volume and the footprint of the massage apparatus should be as small as possible.

A further object of the invention is to provide an advantageous massage nozzle device. Such an advantageous massage nozzle device should in particular be able to be used in a massage apparatus according to the invention.

A massage nozzle device according to the invention should be particularly cost-effective to manufacture. It should be flexible in use, durable and cost-efficient to maintain.

These and other objects are solved by a massage apparatus according to the invention and a massage nozzle device according to the invention according to the independent claims. Further advantageous embodiments are given in the dependent claims.

The solution according to the invention can be further improved by various embodiments, each of which is advantageous in its own right and, unless otherwise stated, can be combined with one another. These embodiments and the advantages associated with them are discussed below.

A first aspect of the invention relates to a massage apparatus for dry hydromassage.

A massage apparatus according to the invention comprises a basic structure and a massage module comprising a substantially closed container having a wall; a flexible membrane forming part of the wall of the container, having a first surface towards the interior of the closed container; and at least one massage nozzle device arranged to direct a liquid jet inside the closed container onto the first surface of the flexible membrane. The massage apparatus further comprises a drive module which is arranged to move the massage module in at least one direction of movement.

The flexible membrane is advantageously impermeable to liquids.

With such a massage apparatus according to the invention, a force can be transmitted from the liquid jet to the membrane at the point where the liquid jet of the massage nozzle devices meets the flexible membrane, and from the membrane directly or indirectly to the body tissue of a body of a user to be massaged which is adjacent to the membrane. Since the user is separated from the massage nozzle device by the membrane, the user does not come into contact with the liquid. Such a massage apparatus according to the invention can thus be used like a mechanical massage apparatus, with the massage effect of a wet massage with water jets. The jet intensity has a balanced effect that is pleasantly perceived by the user.

Since the massage module can be moved, it is possible to make the dimensions of the massage module, in particular the flexible membrane of the container, smaller than the actual effective range of the massage apparatus according to the invention. If a point outside the massage area of the massage module is to be massaged, the massage module can be moved to the corresponding point by the drive module. This reduces the weight of the massage apparatus. In the case of massage apparatus with an inclined effective surface, problems with bulging of the flexible membrane can be avoided by varying the hydrostatic pressure.

In an advantageous embodiment, the massage module can act directly on the body of the user to be massaged.

In another advantageous embodiment of a massage apparatus according to the invention, a flexible layer is provided on the side of the flexible membrane of the massage module facing away from the container, which is fixedly mounted with respect to the basic structure of the massage apparatus.

In particular, this flexible layer can be designed as part of a massage apparatus chair or lounger. For example, this flexible layer can form the backrest of a chair of the massage apparatus.

The flexible layer can be designed, for example, as a membrane or film, as a textile surface, as a foam layer or as a mesh structure. It must be sufficiently flexible to deform in a similar way under the force of the flexible membrane of the massage module, which is pressed outwards by the fluid jet of the massage module, and thus transmit a force to the body of a user. The flexible layer must also be sufficiently stable to withstand the weight of the user. The static friction between the flexible membrane of the massage module and the flexible layer is advantageously as low as possible in order to reduce material wear. This can be achieved, for example, by a suitable choice of materials, by coating the flexible membrane and/or the flexible layers, or by using suitable lubricants.

The massage nozzle device can be a simple nozzle, with a nozzle tube that can form liquid into the most focused, directed liquid jet possible, which can bridge a certain distance in the liquid in the container of the massage apparatus to reach the membrane.

The massage nozzle device may also be a massage nozzle device according to the invention as it will be discussed further below.

The closed container of the massage module is advantageously filled with a liquid or can be filled with a liquid.

Advantageously, the container is filled with liquid during operation so that a liquid jet generated by the massage nozzle device moves within the liquid in the container. This can reduce noise development.

However, the container may also not be filled or only partially filled with liquid. In such an embodiment, a liquid jet generated by the massage nozzle device moves through air or a gaseous phase in the container. Liquid that bounces off the flexible membrane collects at the bottom of the container and is returned to the pump circuit.

Water is preferably used as the liquid. If necessary, other components can be added, such as compounds that prevent the growth of bacteria or algae. Another advantageous type of liquid is silicone oils, as these are non-toxic and non-flammable.

In a massage apparatus according to the invention, a second surface of the membrane facing away from the first surface of the membrane can also be in contact with liquid.

For example, a massage apparatus according to the invention can be combined with a bathtub or similar device, whereby the massage apparatus is installed in the bathtub in such a way that the membrane forms part of the bathtub wall and the massage nozzle devices of the massage apparatus are located outside the bathtub.

In such an embodiment, the bath water in the bathtub can also be used as the liquid in the massage apparatus.

However, the two systems are advantageously separate, as this prevents contamination from the bath water entering the fluid system of the massage apparatus. The fluid in the massage apparatus can therefore be optimized for the intended use.

In a massage apparatus according to the invention, the flexible membrane and a rigid cover together advantageously form a flat wall of the container of the massage module.

In an advantageous embodiment, a massage apparatus according to the invention has a pump module for supplying the at least one massage nozzle device of the massage module with pressurized liquid.

The pump module may comprise a pump and a drain conduit fluidly connecting the container of the massage module and a pump inlet of the pump; wherein an inlet opening of the drain conduit is arranged in a wall of the container adjacent to the rigid cover.

In another advantageous embodiment, a massage apparatus according to the invention has a control module which is set up to control the drive module and/or the massage module.

Such a control module is advantageously set up to control a pump module that may be present.

Advantageously, the jet intensity of the massage nozzle device can be adjusted, for example by controlling the massage nozzle device and/or by controlling the pump output of the pump module.

The massage effect can be kept constant or controlled according to body region by means of a controlled jet intensity.

Advantageously, in a massage apparatus according to the invention, the position and/or orientation of the at least one massage nozzle device can be changed such that the directed liquid jet can be directed to different points on the first surface of the flexible membrane.

In a further advantageous embodiment of a massage apparatus according to the invention, the drive module is arranged to move the massage module in a plane.

In yet another advantageous embodiment of a massage apparatus according to the invention, the drive module is arranged to move the massage module along a curved path in space.

In yet another advantageous embodiment of a massage apparatus according to the invention, the drive module is arranged to rotate the massage module about an axis in space.

In an advantageous embodiment of a massage apparatus according to the invention, the flexible membrane of the massage module has at least one structuring feature which is arranged to adjust the mechanical properties of the flexible membrane.

Advantageously, in such an embodiment, the at least one structuring element is molded or glued onto the flexible membrane of the massage module, so that the flexible mem-brane is locally stiffened.

In a further advantageous embodiment of a massage apparatus according to the invention, a device is provided with which the temperature of the liquid, in particular of the liquid in the container, can be adjusted and/or changed.

In yet another advantageous embodiment of a massage apparatus according to the invention, a heating device is provided with which the temperature of a contact surface of the massage apparatus can be adjusted.

Such a heating device makes it possible to give the user lying on the massage apparatus a pleasant feeling of warmth. Another advantage of such a heating device is that there is no need to heat the liquid in the massage module, which reduces energy consumption.

Advantageously, the heating device is provided with a plurality of heating zones that can be individually selected by the user, for example, in order to set the desired temperature of the heating zone.

Such a heating device can be realized with electric heating wires, for example, or with inserted thin heating hoses.

Such a heating device is advantageously provided as a separate layer, which is arranged between the flexible membrane and a support mat arranged on the flexible membrane. This has the particular advantage that the support mat can be removed more easily for cleaning without having to manipulate the connections of the heating device.

Alternatively, the heating device can also be integrated into a support mat arranged on the flexible membrane or connected to the support mat.

This is particularly advantageous because the body of the user being massaged is in thermally conductive contact with the membrane and thus with the liquid of the massage apparatus. By increasing the temperature of the fluid above room temperature, for example to body temperature or above, the well-being of the user can be increased, and the physiologically positive effect of the massage enhanced. Alternatively, a temperature below room temperature can also be used, for example for therapeutic reasons.

A second aspect of the invention relates to a massage apparatus for dry hydromassage.

A massage apparatus according to the invention comprises a massage module having a substantially closed container with a wall; a flexible membrane forming part of the wall of the container with a first surface towards the interior of the closed container; and at least one massage nozzle device arranged to direct a liquid jet inside the closed container onto the first surface of the flexible membrane. The flexible membrane of the massage module has at least one structuring feature which is arranged to adjust the mechanical properties of the flexible membrane.

Modifying the structural properties of the flexible membrane in this way makes it possible, for example, to adjust the mechanical deformation of the flexible membrane based on the force of the liquid jet.

Advantageously, the at least one structuring element is molded or glued onto the flexible membrane of the massage module, so that the flexible membrane is locally stiffened.

In an advantageous embodiment, a massage apparatus according to the invention has a basic structure and a drive module which is arranged to move the massage module in relation to the basic structure in at least one direction of movement.

The closed container of the massage module is advantageously filled with a liquid or can be filled with a liquid.

In a massage apparatus according to the invention, the flexible membrane and a rigid cover together advantageously form a flat wall of the container of the massage module.

In an advantageous embodiment, a massage apparatus according to the invention has a pump module for supplying the at least one massage nozzle device of the massage module with pressurized liquid.

The pump module may comprise a pump and a drain conduit fluidly connecting the container of the massage module and a pump inlet of the pump; wherein an inlet opening of the drain conduit is arranged in a wall of the container adjacent to the rigid cover.

In another advantageous embodiment, a massage apparatus according to the invention has a control module which is set up to control the massage module.

Such a control module is advantageously set up to control a drive module and/or pump module that may be present.

In a further advantageous embodiment of a massage apparatus according to the invention, the drive module is arranged to move the massage module in a plane.

In yet another advantageous embodiment of a massage apparatus according to the invention, the drive module is arranged to move the massage module along a curved path in space.

In yet another advantageous embodiment of a massage apparatus according to the invention, the drive module is arranged to rotate the massage module about an axis in space.

A third aspect of the invention relates to a massage apparatus for dry hydromassage.

A massage apparatus according to the invention comprises a massage module having a substantially closed container with a wall; a flexible membrane forming part of the wall of the container with a first surface towards the interior of the closed container; and at least one massage nozzle device arranged to direct a liquid jet inside the closed container onto the first surface of the flexible membrane. The flexible membrane and a rigid cover together form a flat wall of the container of the massage module.

Advantageously, in such a massage apparatus according to the invention, the pump module comprises a pump and a drain conduit. The drain conduit fluidically connects the container of the massage module and a pump inlet of the pump. An inlet opening of the drain conduit is arranged in a wall of the container, which is adjacent to the rigid cover.

A fourth aspect of the invention relates to a massage nozzle device for generating a directed liquid jet.

A massage nozzle device according to the invention comprises a nozzle element having a nozzle tube for generating a directed liquid jet, the nozzle tube having an inlet opening at a first longitudinal end and an outlet opening at a second longitudinal end; and a hydraulic actuator operatively connected to the nozzle element and arranged to effect a displacement of the nozzle element along a longitudinal axis of the nozzle tube from a retracted position to an extended position.

Such a massage nozzle device according to the invention allows the nozzle tube to be variably positioned along a longitudinal axis, whereby this movement of the nozzle tube in one direction takes place hydraulically.

The extension length of the nozzle element of a massage nozzle device according to the invention, i.e., the distance between the nozzle element in the retracted position and the same nozzle element in the extended position, should be sufficient so that the nozzle element is always as close as possible to the body of the user to be massaged during operation. The extension length of the nozzle element can be between 5 cm and 10 cm, for example 6 cm.

Water is advantageously used as the liquid for operating a massage nozzle device according to the invention. If necessary, other components can be added, for example compounds that prevent the growth of bacteria or algae. Another advantageous type of liquid is silicone oils, as these are non-toxic and non-flammable.

The components of a massage nozzle device according to the invention are advantageously made of materials which can withstand the pressures and forces during operation, even over long periods of time. Furthermore, the materials should be insensitive, in particular corrosion-resistant, to the components of the liquid used. Advantageously, the components are made of suitable plastic materials. Such materials can be processed efficiently, for example by injection molding.

A displacement of the nozzle element along the longitudinal axis of the nozzle tube from the extended position to the retracted position can be caused passively by the weight of the nozzle element.

In particular embodiments of the invention, this displacement of the nozzle element can also be replaced by a change in the geometry of the nozzle tube itself, in that this has an expandable (and retractable or length-controllable) tube design. This can be achieved, for example, by stretching the outer wall of the tube. Advantageously, this can also be provided only in the end area of the pipe outlet.

In an advantageous embodiment, a return element can be provided which exerts a force on the nozzle element along the longitudinal axis of the nozzle tube from the extended position to the retracted position, for example a weight element or a return spring element.

Such an embodiment has the advantage that when the nozzle element is moved in the direction of the extended position, the hydraulic actuator simultaneously charges the re-set element with the necessary potential energy, which can later move the nozzle element in the direction of the retracted position.

In another advantageous embodiment of a massage nozzle device according to the invention, the hydraulic actuator is set up so that it can cause a displacement of the nozzle element along the longitudinal axis from the extended position to the retracted position.

Advantageously, such a massage nozzle device according to the invention has a feed conduit for supplying the nozzle element with pressurized liquid for generating the directed liquid jet, wherein the feed conduit is arranged to also supply the hydraulic actuator with pressurized liquid for operating the hydraulic actuator.

Such an embodiment has the advantage that no separate hydraulic system is required for the hydraulic actuator of the massage nozzle device according to the invention. The nozzle element and hydraulic actuator of the massage nozzle device can be supplied with pressurized fluid via a common system.

Alternatively or additionally, an advantageous embodiment of a massage nozzle device according to the invention comprises a hydraulic actuator with a first hollow cylinder and a first piston head, which is arranged in the first hollow cylinder and is displaceable along the longitudinal axis between a retracted position and an extended position. The nozzle tube is operatively connected to the first piston head in such a way that a displacement of the first piston head along the longitudinal axis causes a displacement of the nozzle tube along the longitudinal axis. The first hollow cylinder has an opening at one longitudinal end through which the nozzle tube of the nozzle element runs.

Such a massage nozzle device according to the invention allows the nozzle tube to be variably positioned along a longitudinal axis, whereby this movement of the nozzle tube in one direction takes place hydraulically. If pressure is applied to the first hollow cylinder on one side of the piston head, the pressure difference between the two sides of the piston head causes a hydraulic force along the longitudinal vector.

Advantageously, in a massage nozzle device according to the invention, the first hollow cylinder is designed as a circular cylinder.

The design of the first hollow cylinder as a circular cylinder allows the design of the massage nozzle device to be simple and ensures reliable operation. In such a case, the first piston head, which is shaped to match the internal cross-section of the first hollow cylinder, is circular, which makes it possible to achieve a high fitting accuracy without great manufacturing effort.

Other cross-sectional shapes of the first hollow cylinder are also possible, for example elliptical cross-sections or rectangular cross-sections with rounded edges. However, such design variants are more complex in terms of manufacturing tolerances and are more susceptible to mechanical faults, in particular tilting of the piston head in the hollow cylinder.

The inlet opening of the nozzle tube of such a massage nozzle device according to the invention is advantageously arranged in the first piston head.

This makes it possible to draw the pressurized fluid required to generate the directed fluid jet with the nozzle tube from the hollow element of the hydraulic actuator. The supply conduit for the hydraulic fluid thus also serves as a supply conduit for the nozzle element. There is no need for a separate supply conduit for the nozzle element, which allows for a simple design of the massage nozzle device.

The inlet opening of the nozzle tube is arranged in the center of the first piston head, which is particularly advantageous. This allows the most energy-efficient, turbulence-free flow of liquid possible through the massage nozzle device to the outlet of the nozzle tube. Alternatively, the inlet opening can be positioned differently, and/or there can be several inlet openings. In any case, it is advantageous to design the inlet opening in such a way that force vectors transverse to the longitudinal axis of the nozzle tube, which are caused by a deflection of the liquid flows, are canceled out. Lateral forces, which could cause the first piston head to tilt in the first hollow cylinder, are thus avoided.

In an advantageous embodiment of a massage nozzle device according to the invention, the hydraulic actuator advantageously has a first reset element, which applies a force to the first piston head along the longitudinal axis in the direction of the retracted position in the first hollow cylinder.

Such a reset element supports or causes the nozzle tube to return to its original position when the hydraulic force is removed due to a drop in the operating pressure of the fluid.

Such a reset element can be designed as a weight element, for example, which is attached to the nozzle element or the first piston. If the longitudinal axis is parallel to the vertical, the additional weight of the weight element causes a weight force along the longitudinal axis. Since the gravitational force sub-vector decreases along the longitudinal axis with a cosine function as the angle between the longitudinal axis and the vertical increases, and the gravitational force sub-vector acting transverse to the longitudinal axis favors tilting of the piston head in the hollow element, such a reset element is only effective for massage nozzle devices with an essentially vertically aligned longitudinal axis.

Such a resetting element can also be designed as a spring element, for example in the form of a gas pressure spring or a spiral pressure spring. Such a spring element is tensioned when the nozzle element is extended from the first hollow cylinder, so that the first piston head is subjected to a spring force that counteracts the hydraulic force.

As the restoring force is independent of the orientation of the massage nozzle device in the room, such a variant of a massage nozzle device can be used more widely.

The reset element is particularly advantageous in the form of a spiral compression spring. Spiral compression springs are inexpensive and less susceptible to repair. They are small in size and can be easily integrated into a massage nozzle device according to the invention.

In a massage nozzle device according to the invention, the nozzle tube is advantageously connected to or molded onto the first piston head.

Such a design allows the hydraulic force acting on the piston head to be transmitted directly to the nozzle tube of the nozzle element to be moved, and a simple and space-saving design of the hydraulic actuator.

In yet another advantageous embodiment of a massage nozzle device according to the invention, the nozzle tube is designed in two parts, with a first part which is connected to or molded onto the first piston head, and with a second part which is connected to the first part in a fluid-tight manner and on which the outlet opening is arranged. The second part of the nozzle tube is connected to or molded onto a second piston head. The first part of the nozzle tube has a second hollow cylinder in which the second piston head of the second part of the nozzle tube is arranged and can be moved back and forth along the longitudinal axis between a retracted position and an extended position. This second hollow cylinder has an opening at a longitudinal end opposite the first piston head, through which the second part of the nozzle tube extends.

Such a two-part design of the nozzle tube allows the nozzle element to be extended telescopically. Accordingly, the overall height of the massage nozzle device can be reduced relative to the maximum travel of the nozzle tube. The height of the liquid container, and therefore the total volume, can be reduced.

Similarly, the nozzle tube can also be made up of three or more parts, with hollow cylinders that are arranged telescopically one inside the other.

The second hollow cylinder of the first part of the nozzle tube is advantageously a circular cylinder. The explanations regarding the first hollow cylinder apply analogously to the second hollow cylinder.

Particularly advantageously, in such a massage nozzle device according to the invention, the nozzle element has a second reset element, which applies a force to the second piston head of the second part of the nozzle tube along the longitudinal axis in the direction of the retracted position in the second hollow cylinder of the first part of the nozzle tube.

The explanations regarding the first resetting element apply analogously to the second resetting element.

In an advantageous embodiment of a massage nozzle device according to the invention, the nozzle element has two or more outlet openings.

Advantageously, in a massage nozzle device according to the invention the nozzle element has a head piece at the second longitudinal end of the nozzle tube, on which an outlet opening of the nozzle element is arranged.

The head piece protrudes particularly advantageously at the second longitudinal end of the nozzle tube transversely to the longitudinal axis over the nozzle tube.

The head piece of the nozzle element of such a massage nozzle device according to the invention is advantageously mounted so as to be rotatable about the longitudinal axis. The head piece has one or more outlet openings which are designed in such a way that the jets of liquid emerging from the outlet openings exert a rotational force on the head piece, which causes the head piece to rotate about the longitudinal axis.

Such an embodiment of a massage nozzle device allows the at least one directed liquid jet to rotate around the longitudinal axis, which can result in an optimization (expansion, strength and/or direction) of the liquid jet or an oscillating massage effect. Depending on the orientation of the directed liquid jet, a more extensive massage effect can also be achieved, or the same massage effect can be achieved with a lower liquid flow rate and increased pump pressure, which is more energy-efficient.

A massage nozzle device according to the invention can be advantageously used in a massage apparatus according to the invention, as it has been discussed above.

A fifth aspect of the invention relates to a massage apparatus for hydromassage, in particular for dry hydromassage.

A massage apparatus according to the invention comprises a container filled or fillable with a liquid; a flexible membrane, a first surface of the membrane being in contact with the liquid when said container is filled with the liquid; at least one massage nozzle device adapted to direct a liquid jet onto the first surface of the flexible membrane; a pump device adapted to supply liquid under pressure to the at least one massage nozzle device; and a control unit adapted to adjust the strength of a directed liquid jet of a particular massage nozzle device; a pump device adapted to supply liquid under pressure to said at least one massage nozzle device; and a control unit which, for adjusting the strength of a directed liquid jet of a particular massage nozzle device, is adapted to control said pump device and/or said at least one massage nozzle device.

With such a massage apparatus according to the invention, a force can be transmitted from the liquid jet of the massage nozzle device to the membrane at the point where the liquid jet meets the flexible membrane, and from the membrane to the body tissue of a body of a user to be massaged which is adjacent to the membrane. Since the user is separated from the massage nozzle device by the membrane, the user does not come into contact with the liquid. Such a massage apparatus according to the invention can thus be used like a mechanical massage apparatus, with the massage effect of a wet massage with water jets. The jet intensity has a balanced effect that is pleasantly perceived by the user, whereby the massage effect can be controlled either constantly or according to body region by controlling the jet intensity in accordance with the invention.

The jet intensity of a massage nozzle device is preferably set to a desired value by controlling it directly from a control unit in order to influence the liquid jet.

Alternatively or additionally, in a massage apparatus according to the invention, a second surface of the membrane facing away from the first surface of the membrane may also be in contact with liquid.

For example, a massage apparatus according to the invention can be combined with a bathtub or similar device, whereby the massage apparatus is installed in the bathtub in such a way that the membrane forms part of the bathtub wall and the massage nozzle devices of the massage apparatus are located outside the bathtub.

In such an embodiment, the bath water in the bathtub can also be used as the liquid in the massage apparatus.

However, the two systems are advantageously separate, as this prevents contamination from the bath water entering the fluid system of the massage apparatus. The fluid in the massage apparatus can therefore be optimized for the intended use.

Water is advantageously used as the liquid in the massage nozzle device according to the invention. If necessary, other components can be added, for example compounds that inhibit the growth of bacteria or algae. Another advantageous type of liquid is silicone oils, as these are non-toxic and non-flammable.

The massage nozzle device can be a simple nozzle, with a nozzle tube that can form liquid into the most focused, directed liquid jet possible, which can bridge a certain distance in the liquid in the container of the massage apparatus to reach the membrane.

It was found that the pressure difference at the massage point, namely at the point where the directed liquid jet strikes the membrane, decreases linearly compared to other points on the membrane as the distance between the membrane and the nozzle outlet opening increases. For example, with a certain configuration of a fixed massage nozzle device, the pressure difference at a distance of 35 mm is 6.5 bar at constant pump pressure, and at a distance of 95 mm the pressure difference is still 4.0 bar. Accordingly, to achieve an identical pressure difference at the massage point at a distance of 95 mm, the pump pressure must be increased, which causes a significantly higher energy consumption for the pump of 30-50%.

Advantageously, in a massage apparatus according to the invention, the at least one massage nozzle device is a massage nozzle device according to the invention as described above.

One of the advantages of using massage nozzle devices according to the invention in a massage apparatus according to the invention is that the position of the nozzle outlet of the nozzle element is always optimally close to the flexible membrane. It is therefore not necessary to increase the operating pressure in order to generate the same massage force if the distance between the nozzle outlet and the membrane is too great.

Advantageously, in a massage apparatus according to the invention, the container and the flexible membrane form a substantially closed inner volume, wherein the at least one massage nozzle device is arranged in the closed inner volume of the container.

Advantageously, in a massage apparatus according to the invention, the position and/or orientation of the at least one massage nozzle device can be changed such that the directed liquid jet can be directed to different points on the first surface of the flexible membrane.

In such an embodiment of a massage apparatus according to the invention, a larger area of the membrane can be treated in particular with the same number of massage nozzle devices. For example, a massage nozzle device can be arranged on a linearly displaceable carriage.

In a further advantageous embodiment of a massage apparatus according to the invention, a device is provided with which the temperature of the liquid in the liquid container can be adjusted and/or changed.

In yet another advantageous embodiment of a massage apparatus according to the invention, a heating device is provided with which the temperature of a contact surface of the massage apparatus can be adjusted.

Such a heating device makes it possible to give the user lying on the massage apparatus a pleasant feeling of warmth. Another advantage of such a heating device is that there is no need to heat the liquid in the massage module, which reduces energy consumption.

Advantageously, the heating device is provided with a plurality of heating zones that can be individually selected by the user, for example, in order to set the desired temperature of the heating zone.

Such a heating device can be realized with electric heating wires, for example, or with inserted thin heating hoses.

Such a heating device is advantageously provided as a separate layer, which is arranged between the flexible membrane and a support mat arranged on the flexible membrane. This has the particular advantage that the support mat can be removed more easily for cleaning without having to manipulate the connections of the heating device.

Alternatively, the heating device can also be integrated into a support mat arranged on the flexible membrane or connected to the support mat.

This is particularly advantageous because the body of the user being massaged is in thermally conductive contact with the membrane and thus with the liquid of the massage apparatus. By increasing the temperature of the fluid above room temperature, for example to body temperature or above, the well-being of the user can be increased and the physiologically positive effect of the massage enhanced. Alternatively, a temperature below room temperature can also be used, for example for therapeutic reasons.

Massage nozzles according to the invention are advantageously used for massage apparatus according to the invention.

Further aspects of the present invention are also apparent from the following description.

### BRIEF DESCRIPTION OF THE DRAWINGS

For a better understanding of the present invention, reference is made below to the drawings. These merely show embodiments of the object of the invention. Identical or similar reference signs are used in the following figures and the associated description for parts which are the same or have the same effect.

FIG. 1 schematically shows a possible embodiment of a massage apparatus according to the invention.

FIG. 2 schematically shows a massage apparatus according to the invention with a flexible layer between the massage module and the user's body.

FIG. 3 shows a possible embodiment of a massage apparatus according to the invention, at two different displacement positions.

FIG. 4 shows the massage apparatus according to the invention of FIG. 3 in combination with a swivel-mounted armchair-shaped couch.

FIG. 5 shows a schematic side view of a further possible embodiment of a massage apparatus according to the invention with a curved path of movement of the massage module along the (a) longitudinal contour and (b) the transverse contour of a chair of the massage apparatus.

FIG. 6 schematically shows a possible embodiment of a massage module for a massage apparatus according to the invention, with a massage nozzle device that can be displaced within the container of the massage module.

FIG. 7 schematically shows another possible embodiment of a massage module for a massage apparatus according to the invention, with several selectively controllable massage nozzle devices.

FIG. 8 schematically shows another possible embodiment of a massage module for a massage apparatus according to the invention, with a padding element with a recess for the active area.

FIG. 9 shows a schematic view of various options (a)-(d) for adjusting the behavior of a flexible membrane of a massage module using structuring elements.

FIG. 10 shows another embodiment of a massage apparatus according to the invention, in a perspective view.

FIG. 11 shows a longitudinal section of the massage apparatus in FIG. 10.

FIG. 12 schematically illustrates a massage nozzle device according to the invention in a massage apparatus according to the invention.

FIG. 13 shows a possible embodiment of a massage nozzle device according to the invention, with partially extended nozzle element.

FIG. 14 shows a longitudinal section through the massage nozzle device according to the invention of FIG. 13, (a) with the nozzle element fully retracted, and (b) with the nozzle element fully retracted.

FIG. 15 shows a longitudinal section through a further embodiment of a massage nozzle device according to the invention with a reset element, (a) with the nozzle element fully retracted, and (b) with the nozzle element fully retracted.

FIG. 16 schematically shows a massage apparatus according to the invention, with another embodiment of a massage nozzle device according to the invention at various positions along a transverse displacement path.

FIG. 17 shows a longitudinal section through a further embodiment of a massage nozzle device according to the invention with a three-part telescopic mechanism, (a) with the nozzle element fully retracted, and (b) with the nozzle element fully extended.

FIG. 18 shows a longitudinal section through an embodiment of a massage nozzle device according to the invention with a three-part telescopic mechanism and reset elements, (a) with the nozzle element fully retracted, and (b) with the nozzle element fully extended.

FIG. 19 shows a top view of the head piece of another embodiment of a massage nozzle device according to the invention with a rotating head piece.

### WAYS TO CARRY OUT THE INVENTION

The examples given below serve to better illustrate the invention but are not intended to limit the invention to the features disclosed herein.

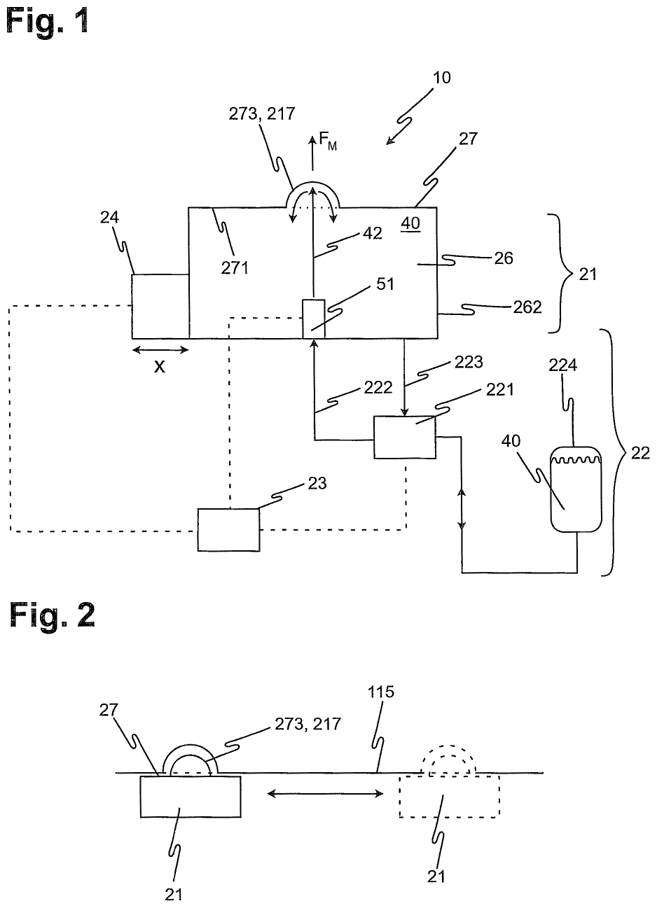

A possible embodiment of a massage apparatus according to the invention is shown schematically in FIG. 1. The massage apparatus 10 shown has a massage module 21, a drive module 24, a pump module 22 and a control module 23.

The massage module 21, which is shown in FIG. 1 in a schematic longitudinal section, comprises a substantially tightly sealed container 26, consisting of a rigid wall 262 in the form of a trough, which is closed with a flexible membrane 27. The container 26 is filled with a liquid 40, for example water or silicone oil. A massage nozzle device 51 is arranged on a wall of the container opposite the membrane 27, which is directed towards the membrane 27.

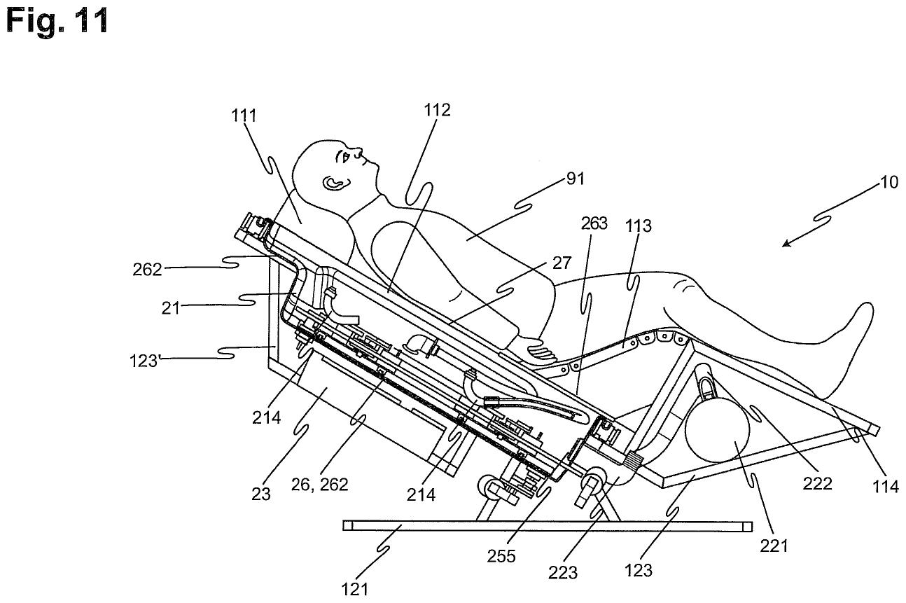

The massage nozzle device 51 can advantageously be realized as a massage nozzle device 51a according to the invention, as also disclosed in FIGS. 11 to 19. However, a conventional nozzle device can also be used.

The pump module 22 comprises a pump 221, which draws relaxed liquid 40 from the container 26 of the massage module 21 via a drain conduit 223 and conveys it back to the massage module 21 in a circuit under pressure via a supply conduit 222. In the massage module 21, the conduit 222 opens into the massage nozzle device 51.

In the embodiment example shown, the pump module 22 also has an optional liquid reservoir 224. For example, the pump 221 can also draw liquid 40 from this reservoir 224 in order to increase the amount of liquid in the container 26. Conversely, liquid can also be pumped into the reservoir 224 in order to reduce the amount of liquid in the container.

The massage nozzle device 51 generates a liquid jet 42, which moves through the stagnant liquid 40 in the container 26 until it strikes the inner surface 271 of the flexible membrane 27 in a massage action area 217. Due to the impulse and the kinetic energy of the impinging liquid, the flexible membrane 217 is pressed outwards in this effective area 217 before the liquid of the jet 42 dissipates into the stagnant liquid 40. If there is resistance to the force of the liquid jet, for example the body tissue of a user to be massaged, a force Fₘ acts on the body tissue in the effective area 217. The massage effect is analogous to a hydromassage, as the liquid jet exerts a force, but in contrast to a mechanical actuator, this is perceived as less “hard” or “uncomfortable”. The massage effect is more comparable to a hand massage because the fluid jet is not unyielding like a mechanical actuator, but is yielding when there is greater resistance, for example in the area of bones close to the body surface.

The drive module 24 is set up to move the massage module 21 together with the container in space, for example along an axis x. In this way, the effective range 217 of the massage module 21 can also be moved, so that a user's body can be massaged at different points. The aforementioned movement of the massage module 21 can be achieved by the drive module 24 using suitable actuators or conveyor means, for example.

The control module 23 is set up to control the massage module 21, the drive module 24 and/or the pump module 22 as required. For this purpose, the control module 23 is connected via control lines to the other modules 21, 22, 24 of the massage apparatus 10 to be controlled.

For example, the control module may be arranged to control the massage nozzle device 51, for example by switching the massage nozzle device on and off by means of a valve in the supply conduit 222. Depending on the structure and functionality of the massage nozzle device 51, the thickness and the scattering angle of the liquid jet 42 may also be controlled, for example.

The control module can also be set up, for example, to control the actuators etc. of the drive module. Alternatively, the control module 23 can also specify a target position of the massage module 21 to the drive module 24, which the drive module 24 then moves to with the aid of its own internal controller.

Finally, the control module can, for example, be set up to control the operating pressure or the delivery rate of the pump module 21 so that the liquid jet 42 has the desired properties (e.g. speed, flow rate). This can be achieved in particular by controlling the pump output of the pump 221.

The displaceability of the massage module 21, and thus of the massage action area 217, allows the volume of the container to be made smaller than is known from the prior art. Accordingly, the weight of the entire massage apparatus 10 can be reduced, since in particular the amount of liquid can be reduced. Also, with an inclined, non-horizontal arrangement of the container 26 (such as in a massage chair), in which the membrane 27 is exposed to a hydrostatic pressure gradient, this pressure gradient is significantly lower than in the prior art. Accordingly, the negative effects of this pressure difference are smaller, so that corresponding technical countermeasures can be dispensed with. For example, if the flexible membrane of a permanently mounted, inclined massage module from the prior art extends over a vertical distance of 1 m, a hydrostatic pressure of approx. 10 kPa acts on the flexible membrane at the lower end of the container when it is filled with water. If, on the other hand, the container of the massage module extends only 0.2 m vertically, notwithstanding the same potential effective range as is possible with a massage apparatus according to the invention, the hydrostatic pressure is only 2 kPa.

A massage apparatus according to the invention can be designed in such a way that the massage module, or more precisely the massage action area of the flexible membrane, acts directly on the user's body. However, since the massage module is movable according to the invention, in an advantageous embodiment of a massage apparatus according to the invention, the movable massage module is separated from the user's body by a fixed flexible layer. In particular, this allows the massage module to be moved easily when the user is already on the massage apparatus.

A schematic representation of such a solution is shown in FIG. 2. The user to be massaged (not shown) is located on a flexible layer 115, which is designed, for example, as a lying surface or as the backrest of a massage apparatus. A massage module 21 is located on the side of the flexible layer 115 facing away from the user. The flexible mem-brane 27 of the massage module is in contact with the flexible layer. When the massage module is activated, the generated fluid jet presses the flexible membrane 27 outwards in the effective area 217, in the example shown upwards. This also deforms the flexible layer 115 so that the massage module 21 can exert a force on the user's body.

Depending on the desired massage effect, the massage module 21 and/or the drive module (not shown) of the massage apparatus can be controlled. For example, the liquid jet can be alternately adjusted and turned off in order to achieve an oscillating force effect in the massage action area 217 (indicated by the vertical double arrow). If the massage active area is to be moved to another part of the body, the drive module moves the massage module 21 parallel to the flexible layer 115 to a desired target location. During this displacement, the massage module can be inactive, only to resume active massaging at the new target location. Alternatively, the massage module may remain active during the displacement, so that the bulging massage active area 217 moves together with the massage module 21. Such a displacement can also be performed in an oscillating pattern (indicated by the horizontal double arrow). A combination of oscillating massage action and horizontal displacement is also possible.

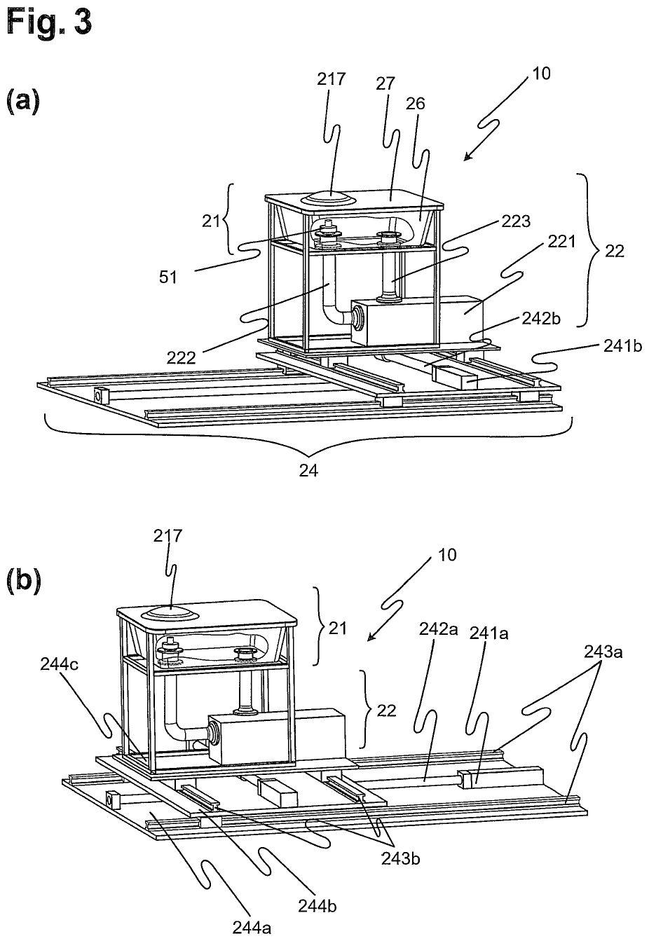

A possible embodiment of a massage apparatus 10 according to the invention is shown in FIG. 3. The massage apparatus 10 comprises a massage module 21, a pump module 22, a drive module 24 and a control module (not shown).

The drive module 24 comprises two linear drives arranged in a crossed arrangement, which enable the massage module 21 to be moved along two horizontal axes of movement x, y. Two running rails 243a are arranged on a first support plate 244a of the drive module 24. A second support plate 244b is mounted on the running rails 243a with four carriages so that it can be moved in a rolling manner. A first linear drive in the form of a spindle drive comprises a servomotor 241a and a threaded spindle 242a (for example a ball screw or trapezoidal threaded spindle), which runs through a spindle nut (not visible) mounted below the second support plate 244b. A rotation of the drive spindle 242a by the servomotor 241a is thus converted into a linear movement of the second support plate 244b along the axis x. Similarly, two running rails 243b are arranged on the second support plate 244b, on which a third support plate 244c with four carriages is arranged to be displaceable in a rolling manner. A second linear drive in the form of a spindle drive comprises a servomotor 241b and a threaded spindle 242b, which runs through a spindle nut (not visible) mounted below the third support plate 244c. Similarly, a rotation of the drive spindle 242b is converted by the servomotor 241b into a linear movement of the third support plate 244c along the axis y.

A frame is arranged on the third support plate 244c, on which the pump module 22 and the massage module 21 are mounted. The massage module 21 has a container 26 filled with liquid, with a rigid wall 26 in the form of a trough, which is closed on an upper side by a flexible membrane 27. The flexible membrane is designed as a support mat. In the context of this description, the term support mat is understood to mean a flexible, elastic mat that is made of an elastomeric polymer material. A support mat can, for example, consist of a natural or artificial rubber material. The elastomeric polymer material can also be designed as an open-pored or closed-pored foam.

The wall of the tub is shown partially transparent, so that the massage nozzle device 51 arranged on the bottom of the tub and the inlet opening of the drain conduit 223 are visible.

The pump module 22 has a pump 221, which draws liquid from the container 26 via a drain conduit 223 and delivers it under pressure to the massage nozzle device 51 via a supply conduit 222. The liquid emerging at high speed from the massage nozzle device 51, which is aligned in the direction of the flexible membrane 27, into the container 26 forms a liquid jet, which ultimately strikes the flexible membrane 27. The liquid jet hitting the flexible membrane 27 pushes the flexible membrane 27 outwards in the massage action area 217.

The drive module 24 can be used to move the third support plate 244c with the massage module 21 and the pump module 22 to any desired position within the range of movement. For example, FIG. 3(a) and 3(b) show the massage module 21 of the massage apparatus 10 at two different positions of the movement axes x and y. Accordingly, the effective range 217 of the massage module 21 can be positioned within the entire range of movement. Such a massage apparatus thus allows massaging in a potential effective area having the same area as is possible with a known massage apparatus, in which the container covers the entire massage area, and the massage nozzle device is moved within the container.

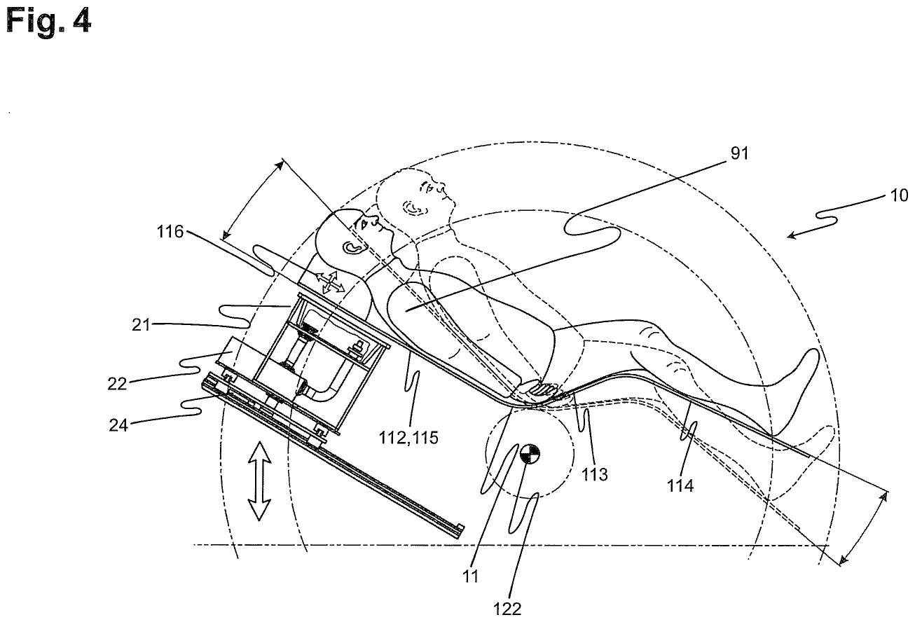

The massage apparatus 10 can be arranged horizontally as shown in the aforementioned FIG. 3, for example as part of a horizontal massage table. Alternatively, the massage apparatus 10 can also be arranged inclined, for example as part of a massage chair 11. Such an embodiment variant of a massage apparatus 10 according to the invention is shown schematically in FIG. 4. The massage apparatus 10 has a chair 11 on which the user 91 sits. The chair 11 comprises a backrest 112, a seat 113 and a leg rest 114. A headrest 116 is displaceably arranged on the backrest 112, so that the massage apparatus can be adapted to the body size of the user 91.

In a central area on which the user 91 rests with his back, the backrest 112 is designed as a flexible layer 115, for example as a flexible yet load-bearing film, or as a small-mesh, flexible net. The massage module 21, the pump module and the drive module 24, correspond to those of FIG. 3 and are arranged below the backrest 112 of the chair 11. The modules 21, 22, 24 and the chair 11 are mounted on a common frame (not shown). The drive module 24 allows the massage module to move in the plane of the backrest 112, so that a massage action area of the massage module 21 can reach all points in the area of the flexible layer 115 of the backrest.

The chair 11 and the modules 21, 22, 23 are pivotally mounted on a base frame (not shown) and can be pivoted through a certain angular range about a horizontal pivot axis 122. This allows the user 91 to assume a more seated or a more reclined position, as required.

Advantageously, in addition to the headrest 116, the position and orientation of the seat 113 and the leg rest 114 in relation to the backrest 112 can also be changed in such a massage apparatus 10 in order to be able to easily adapt the chair 111 to different body sizes of different users.

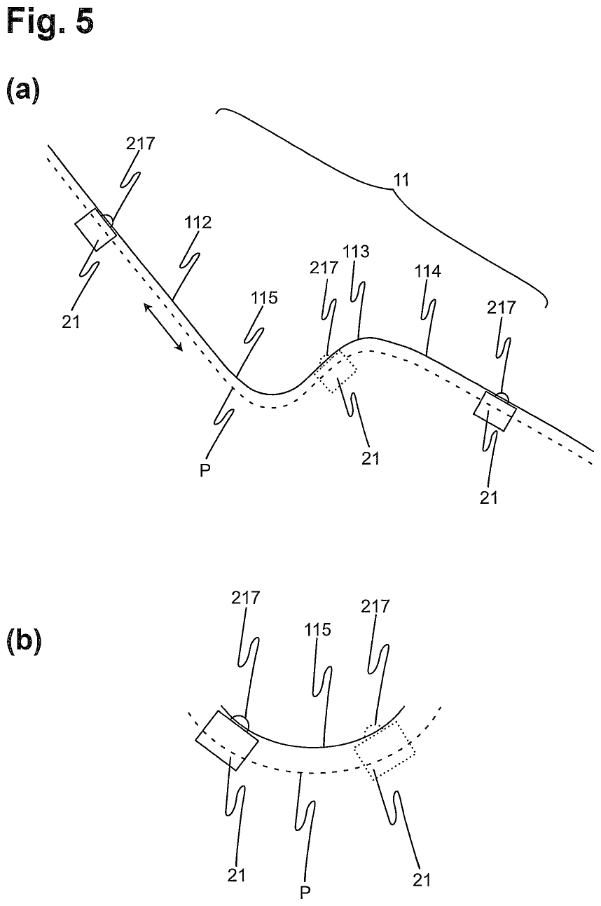

In the aforementioned embodiment example, the flexible layer 115, under which the massage module 21 is displaceably arranged, extends over the backrest 112 of the chair 11 of the massage apparatus 10. In another alternative embodiment, as shown schematically in FIG. 5(a), the flexible layer extends over the entire length of the chair 11. A rail system of a drive module of the massage apparatus 10, indicated by a dashed line, is arranged underneath the flexible layer. This drive module is designed to move the massage module 21 along the movement path P at a constant distance from the flexible layer 115. The massage module 21 always remains aligned perpendicular to the flexible layer 115. This allows the massage module 21 to be able to perform a massage over the entire area of the chair 11, as all positions can be reached in the longitudinal direction. For example, the back of a user can be massaged first, and then the leg area.

A drive module for such a massage apparatus 10 can, for example, be realized with parallel running rails on which a carriage is slidably arranged, on which in turn the massage module 21 is mounted.

In the aforementioned embodiment example, a pump module is advantageously not moved together with the massage module but is permanently mounted in relation to the chair or a support frame (not shown). The pump module (not shown) and the massage module 21 are then connected via flexible conduits.

As in the example shown, two massage modules 21 can also be arranged along the movement path P. These can advantageously be moved independently of each other by the drive module. Such a solution allows a parallel massage in different regions of the user's body.

Alternatively or additionally, a massage apparatus 10 according to the invention may also provide for the massage module 21 to be displaced transversely to the chair along a curved path of movement P, as shown schematically in FIG. 5(b). In this way, it is possible to make a flexible layer 115 of the chair concave in cross-section and still ensure a constant distance between the massage module 21 and the flexible layer. Such a drive can be realized, for example, by the massage module 21 being arranged on a carriage which runs on two rails curved in accordance with the movement path P.

In order to combine the movement from FIG. 5(a) and (b) in a particularly advantageous embodiment of the massage apparatus, the transverse drive from FIG. 5(b) can be arranged on a carriage, which in turn is arranged to be displaceable on rails analogous to FIG. 5(a). In this way, the massage module can reach every point of the intricately shaped chair surface.

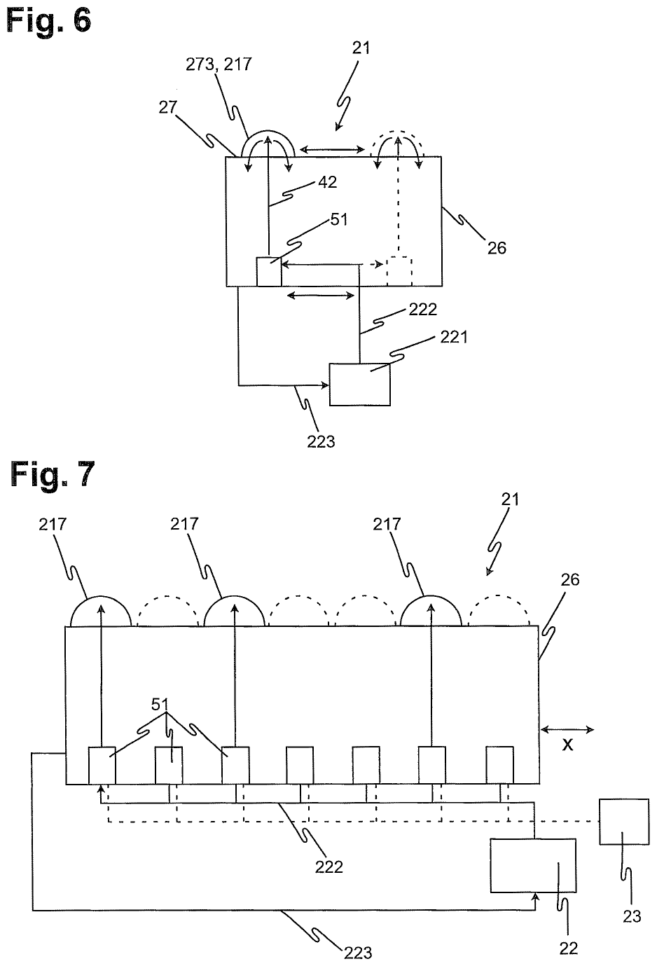

In the massage apparatus discussed above, the massage module comprises only a massage nozzle device 51, which is mounted in a fixed position on the base of the container 26. Alternatively, the massage nozzle device can also be designed to be displaceable, as shown schematically in FIG. 6. In such an embodiment, the massage nozzle device 51 of the massage module 21 is displaceable within the container 26 by means of an actuator (not shown), for example a linear drive or a swivel arm. The massage action area 217 on the flexible membrane 27 also moves accordingly. The actuator for moving the massage nozzle device is preferably controlled via the control module 23 of the massage apparatus 10.

FIG. 7 shows a further advantageous embodiment of a massage apparatus 10 according to the invention. Several massage nozzle devices 51 are arranged at a regular distance from each other on the bottom of the container 26 of the massage module 21. A feed pump 221 of the pump module 22 draws liquid from the interior of the container via a drain conduit 223 and conveys it further to the massage nozzle devices 51 via the feed conduit 222. A control module 23 controls the individual massage nozzle devices 51. For example, electrically controllable valves can be provided in the massage nozzle devices 51, which switch on or interrupt the liquid supply from the supply conduit 222. In this way, the individual massage nozzle devices 51 can be activated in a targeted manner so that the jets of fluid 42 generated by them can generate an outwardly directed force in the effective area of the flexible membrane assigned to them. In the example shown, viewed from the left, the first, third and sixth massage nozzle devices 51 are active, and accordingly the massage module 21 exerts a force on the user's body (not shown) at the first third and sixth massage active areas 217.

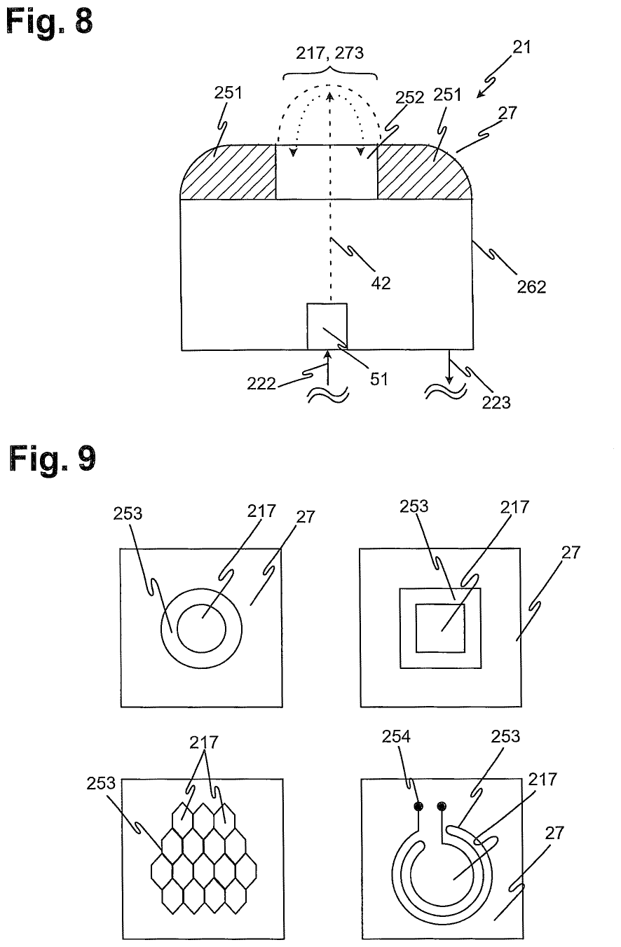

A further advantageous embodiment of a massage module 21 for a massage apparatus according to the invention is shown in FIG. 8. A massage nozzle device 51 is arranged in a container 26, which can generate a liquid jet 42 directed towards the flexible mem-brane 27. A padding element 215 is arranged inside the container, which is connected to the wall 262 and/or the flexible membrane 27. For example, the flexible membrane 27 may be stretched over the padding element 251 attached to the wall 262. The rounded outer edge of the padding element 251 prevents the massage module 21 from catching on a flexible layer (not shown) of the massage apparatus arranged above the massage module 21 when the massage module 21 is displaced horizontally. In the center, the padding element 251 has an opening 226 through which the liquid jet 42 can reach the inside of the flexible membrane 217.

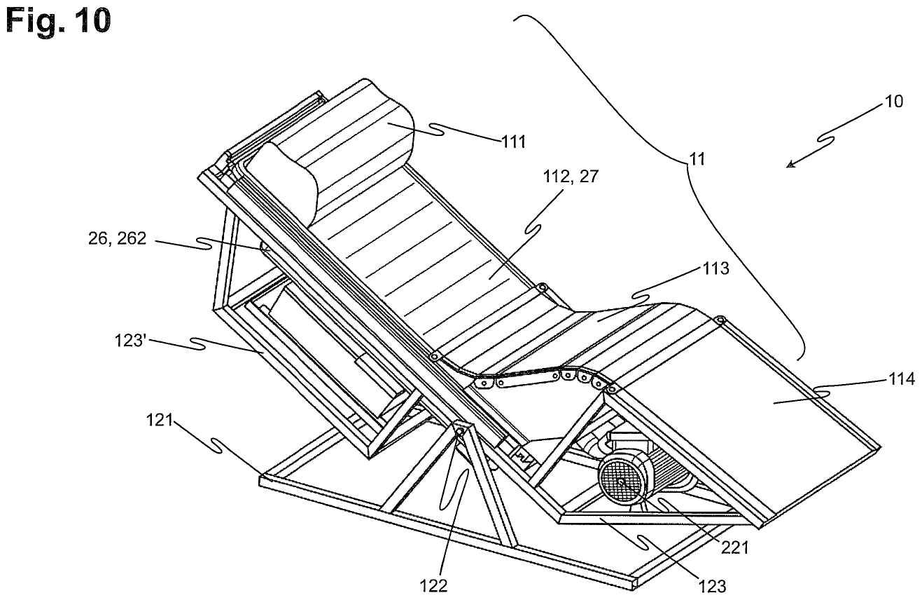

A flexible membrane 27 for a massage module can have a uniform shape. Alternatively, its mechanical properties can also be modified by specifically applied structuring elements 253. FIG. 9(a)-(d) show different variants of such a modified flexible membrane 27.

FIG. 9(a) shows a section of a flexible membrane 27 in which a ring-shaped structuring element 253 is arranged on the membrane. The structuring element 215 can be realized, for example, as a local thickening of the material of the flexible membrane 27, or as a ring which is attached to the outside and/or the inside of the membrane, for example glued on. If a liquid jet is now directed against the surface of the flexible membrane 27 facing the container, it is pressed outwards in the effective area 217, thus exerting the massaging force. The structuring element 253 limits the deformation of the membrane to the inside of the ring-shaped structuring element 253 due to the additional strength of the flexible membrane 27 in this area. Such a structuring element 253 can also have a square design, as shown for example in FIG. 9(b).

Several structuring elements 253 can also be arranged directly adjacent to one another, as shown in the embodiment example in FIG. 9(c). A plurality of hexagonal structuring elements 253 form a honeycomb pattern on the flexible membrane 27. The structuring elements 253 may, for example, be realized as ribs formed or adhered to the membrane. The honeycomb pattern defines a plurality of effective areas 217, each of which is located within a hexagon.

Finally, a further advantageous variant of a structuring element 253 for a flexible mem-brane 27 is shown in FIG. 9(d). The structuring element 253 comprises a thin, flexible pressure conduit which can be filled with liquid or gas, and which is attached to the flexible membrane 27 in the form of a loop. The pressure conduit extends from a first fluid connection 254 to a sealed end 255 of the conduit. If the conduit 253 is filled with pressurized fluid, in particular compressed air, via the fluid connection 254, the conduit 253 stiffens. The structuring element 253 is now active and limits the effective range 217 of the flexible membrane 27. If the fluid pressure is then released from the conduit 253, the conduit 253 becomes flexible again, and the mobility of the flexible membrane 27 is no longer restricted by the deactivated structuring element 253. Such an embodiment of a flexible membrane thus allows the mechanical properties of the flexible membrane 27 to be modified variably over time. For example, the structuring element 253 can only be activated in each case when a massage nozzle device is to become active in the corresponding effective area 217.

Flexible membranes structured in this way can be used not only in the massage apparatus with a movable massage module discussed above, but also in massage apparatus according to the invention with a statically mounted massage module.

An embodiment of a massage apparatus 10 according to the invention with a statically mounted massage module 21 is shown in FIGS. 10 and 11.

A frame 123, 123′ is mounted on a support frame 121 so as to pivot 122 about a horizontal pivot axis. A chair 11 is arranged on the frame 123, 123′, on which a user 91 of the massage apparatus 10 can sit. The chair 11 comprises a leg support 114, a seat area 113, a backrest 112 and a headrest 111. A thin support mat is placed on the chair 11, which is not shown in FIGS. 10 and 11 in order to make the underlying elements visible. Also not shown is an outer covering of the massage apparatus 10.

A massage module 21 and a control module 23 are arranged in a rear part 123′ of the frame below the backrest 112. The massage module 21 comprises a container 26 with a tub-shaped rigid wall 262, which is closed with a flexible membrane 27 and an adjoining rigid cover 263.

In the area of the backrest 112, the thin support mat (not shown) lies directly on the flexible membrane 27 of the massage module 21. In this area, this thin support mat thus forms the flexible layer. The support mat and flexible membrane 27 together form the backrest 112. The rigid cover 263 of the container 26 lies below the seat area 113.

Inside the container 26 filled with liquid, two massage nozzle devices 51 are arranged so that they can be moved by means of actuators, so that essentially every point of the flexible membrane 27 in the area of the backrest can be reached by a liquid jet if required.

A pump 221 of a pump module is arranged in a front part 123 of the frame below the leg support 114, which draws liquid from the container 26 via a drain conduit 223. A supply conduit 222 leads from the pump 221 to the container wall 262. Inside the container, the supply conduits separate into two flexible supply conduits 214, which lead to the two movably arranged massage nozzle device 51.

The positioning of the pump 221 below the leg rest has the advantage that the weight distribution of the pivotable part of the massage apparatus 10 is relatively balanced with respect to the pivot axis 122.

Alternatively, the pump can also be positioned at a different location, for example on the support frame 121 below the pivoting part. In such a case, the pump is connected to the massage module 21 via flexible hoses 222, 223 instead of rigid pipes.

In the aforementioned massage apparatus 10, the container 26 of the massage module 21 may be completely filled with liquid. The flexible membrane 27 of the massage module 21 is advantageously provided with structuring elements which can modify the mechanical properties of the flexible membrane in a desired manner. For example, the structuring elements can be designed as a net structure, for example as a honeycomb net, which is attached to a flexible, elastic polymer film 27. The structuring elements thus give the entire flexible film a certain tensile strength so that it can withstand the hydro-static pressure of the liquid inside the container 26. In the gaps in the mesh structure, in turn, the membrane is sufficiently flexible and elastic that a jet of water from a massage nozzle device 51 can push the membrane outwards, so that a massage effect is achieved.

The embodiment of a massage apparatus 10 shown can alternatively also be operated in a partially filled state. In such a case, the container 26 of the massage module 21 is advantageously filled with liquid at most up to approximately the level of the transition from the lower end of the flexible membrane 27 to the upper end of the rigid cover 263. In this way, the hydrostatic pressure of the liquid only acts on the rigid parts 262, 263 of the container 26. Additional structural reinforcement of the flexible membrane 27 is therefore not necessary. In such a case, the jets of liquid generated by the massage nozzle devices 51 move through the air until they hit the flexible membrane 27. The rebounding liquid then runs off gravity-driven and collects in the lower, liquid-filled area of the container, which serves as a pump sump. The inlet opening 225 of the drain conduit 223 of the pump module 22 is arranged at a lower end of this area, so that the pump 221 cannot run dry even at high liquid throughput.

In an advantageous variant, the volume of the pump sump area of the container of the massage module can be modified, for example by providing a pneumatically inflatable cushion in this area in the container. If the amount of liquid in the container changes, or if the chair of the massage apparatus is swiveled, which changes the position of the liquid level in the container, the volume of the inflatable cushion can be reduced or increased. Accordingly, the position of the liquid level in the container changes upwards or down-wards. Such a change in volume can also be achieved by moving volume elements, for example by the adjustable insertion or withdrawal of a piston through the container wall.

The support mat can be equipped with a heating device to give the user a pleasant feeling of warmth. Such a heating device also has the advantage that there is no need to heat the liquid in the massage module, which reduces energy consumption.

Advantageously, the heating device is provided with a plurality of heating zones that can be individually selected by the user, for example, in order to set the desired temperature of the heating zone.

Such a heating device can be realized with electric heating wires, for example, or with inserted thin heating hoses.

Such a heating device is advantageously provided as a separate layer, which can be arranged between the flexible membrane 27 and the support mat. This has the particular advantage that the support mat can be removed more easily for cleaning without having to manipulate the connections of the heating device.

Alternatively, the heating device can also be integrated into the support mat or connected to the support mat.

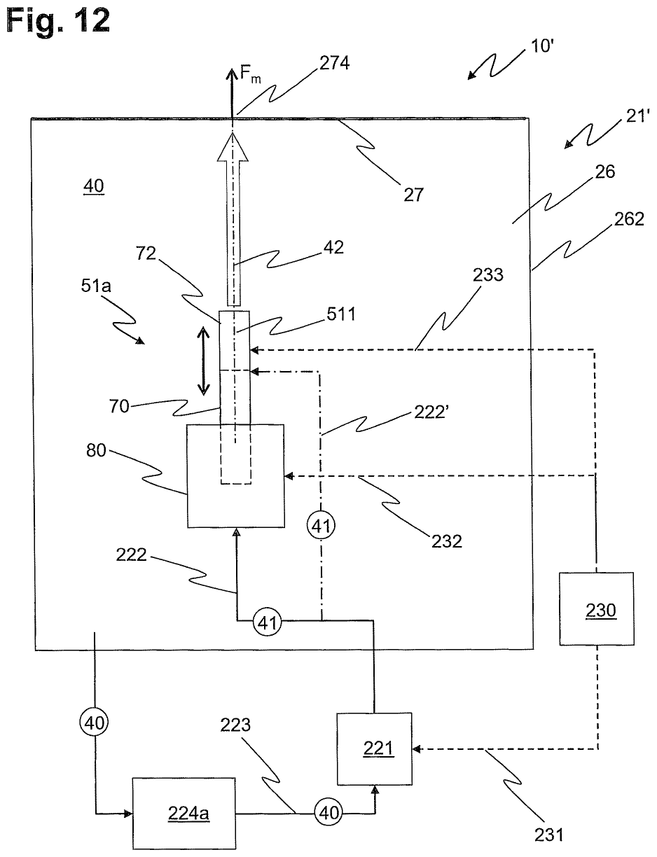

Further advantageous embodiments of a massage apparatus 10′ according to the invention with a massage module 21′ and a massage nozzle device 51a according to the invention are shown schematically in FIG. 12.

The massage module 21′ of the massage apparatus 10′ comprises a container 26, which has a flexible membrane 27 on an upper side. The container is filled with liquid 40. The massage nozzle device 51a is arranged inside the container 26.

The massage nozzle device 51a comprises a nozzle element 70 and a hydraulic actuator 80. The nozzle element 70 has a nozzle tube 72 and is arranged to generate a directed liquid jet 42. The directed liquid jet 42 is directed vertically against the flexible membrane 27 of the massage apparatus 10′, where the liquid jet 42 exerts a force Fm acting essentially vertically outwards on the membrane 27 at the point of impact 274 due to the momentum and the kinetic energy of the moving liquid. This leads to a local deformation (not shown) of the membrane 27, which thus exerts a force on a body of a user (not shown) located on the membrane 27 during the intended operation of the massage apparatus 10′ and thus achieves the desired massage effect.

The nozzle element 70 is supplied with pressurized liquid 41 via a feed conduit 222′, where it is formed into a directed liquid jet 42 by the nozzle tube 72.

The hydraulic actuator 80 is set up to move the nozzle element 70 along a longitudinal axis 511 of the nozzle tube 72 from a retracted position (shown dashed) to an extended position. For example, the nozzle element 70 may simply be attached to an actuator element of the hydraulic actuator 80 that moves along the longitudinal axis 511. The hydraulic actuator 80 can, for example, be designed as a hydraulic piston, in particular as a telescopic cylinder. However, the hydraulic actuator 80 can also be realized differently, for example as an inflatable bellows.

The hydraulic actuator 80 is supplied with pressurized fluid 41 via a feed conduit 222. A pumping device 221 supplies the feed conduit 222, 222′ with pressurized fluid 41 by drawing depressurized fluid 40 from the reservoir 26, either directly or as shown, via an intermediate reservoir 224a.

Instead of via separate supply conduits 222, 222′ for the pressurized fluid 41 as shown, the pressurized fluid 41 can be supplied within the massage nozzle device 51a, either from the nozzle element 70 into the hydraulic actuator 80 or from the hydraulic actuator 80 into the nozzle element 70.

The pumping device 221 can be arranged outside the container as shown, which simplifies maintenance. Alternatively, it can also be arranged as a submersible pump inside the container.

A control unit 230 is provided to control the pump device 221 and/or the massage nozzle device 51a via control lines 231, 232, 233. In the pump device, for example, the pump pressure or the delivery rate can be controlled. In the massage device 51a, the control unit 230 can, for example, control the function of the hydraulic actuator 80 and/or the nozzle element 70, for example by switching corresponding valves (not shown).

Such a control unit 230 can advantageously be integrated into a higher-level control module 23 of the massage apparatus 10′, which controls further functions of the massage apparatus 10′ or the massage module 21′.

The various control lines 231, 232, 233 can be realized as electrical lines, or also as hydraulic switching lines. Hydraulic lines 232, 233 are particularly advantageous for the elements 70, 80 within the container 26 filled with liquid 40 for safety reasons.

The control unit 230 is set up in such a way that it can achieve a desired force effect at the point of impact 274. For this purpose, the control unit 230 can, for example, adjust the operating pressure of the pump device 221. The control unit 230 can change the distance between the nozzle element 70 and the membrane 27 by controlling the hydraulic unit so that it changes the position of the nozzle element along the longitudinal axis 511 as desired. Furthermore, the control unit 230 can, for example, influence the shape of the liquid jet 42 by using suitable means in the nozzle element 70 to make the liquid jet 42 wider or narrower, for example with an orifice in the nozzle tube 72.

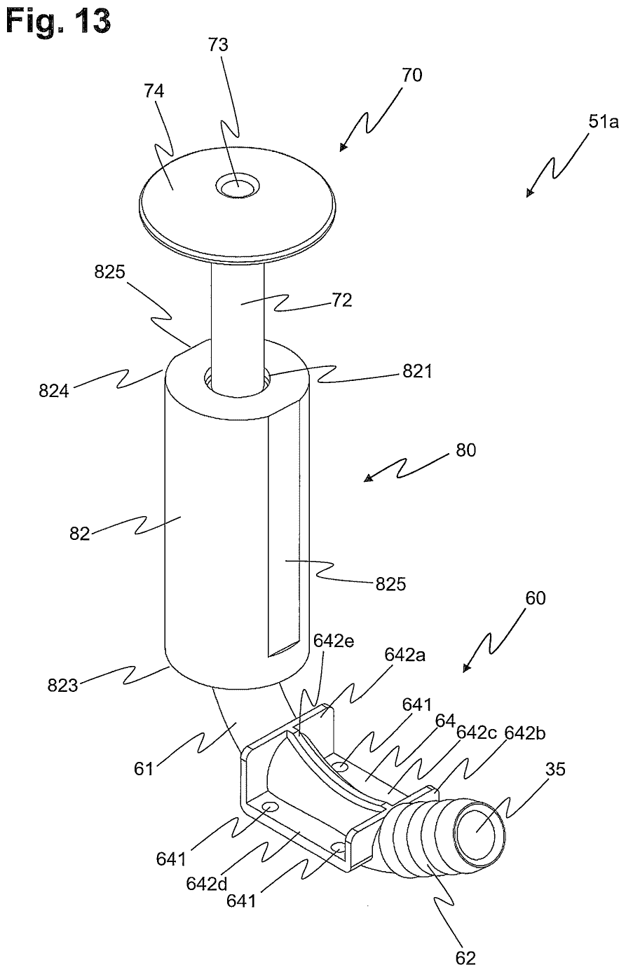

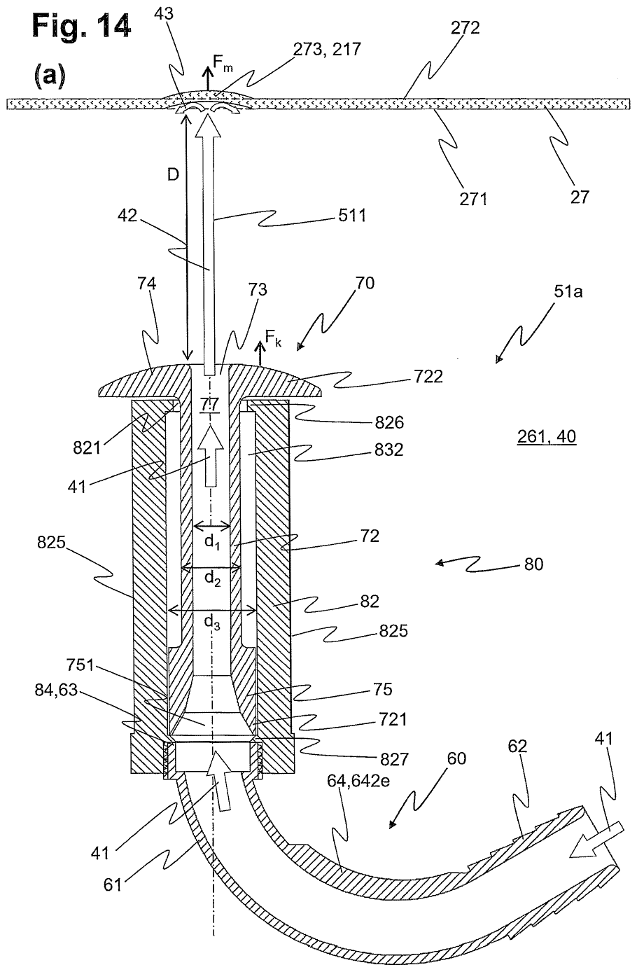

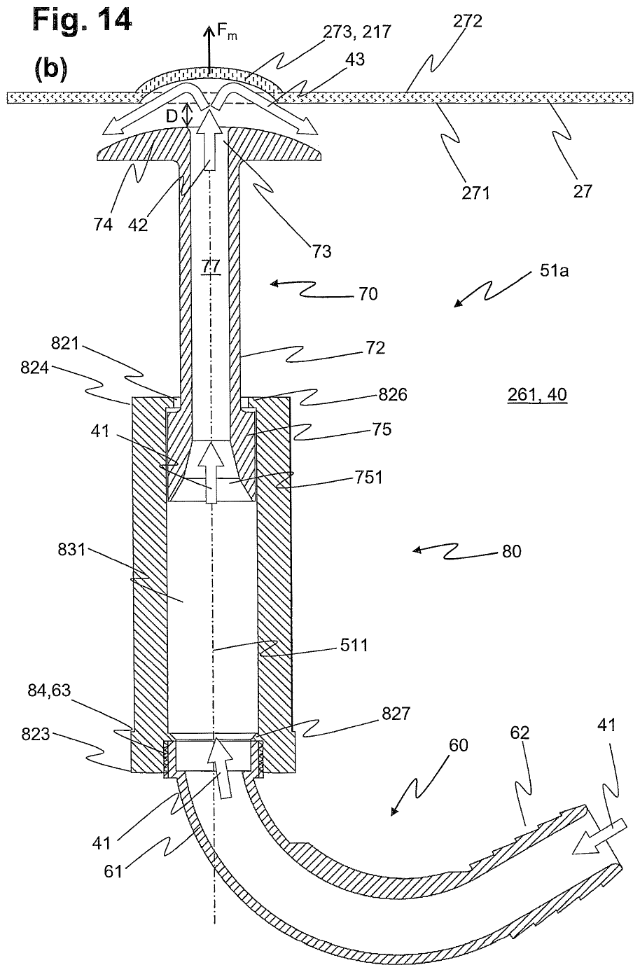

An advantageous embodiment of a massage nozzle device 51a according to the invention is shown in FIGS. 13 and 14. The massage nozzle device 51a comprises a hydraulic actuator 80 and a nozzle element 70 which can be hydraulically extended from the hydraulic actuator 80. The hydraulic actuator 80 is fluidically connected to a feed pipe 60, via which fluid, advantageously water or an aqueous solution, is fed under pressure to the massage nozzle device 51a via a conduit from a pump (both not shown) during operation.

Advantageously, at least some of the components are made of plastic, for example by injection molding, whereby the choice of material also depends, among other things, on the forces and pressures acting. Alternatively, metallic materials can also be used, which are processed using powder injection molding, for example.

In a massage apparatus according to the invention, the massage nozzle device according to the invention is installed inside a closed liquid container (not shown), the interior 261 of which is filled with liquid 40. One wall of the liquid container is designed as a flexible, elastic membrane 27. The massage nozzle device 51a is oriented in such a way that it can direct a directed liquid jet 42 onto the membrane 27 during operation. The massage nozzle device 51a is completely submerged in the liquid. Since the membrane is flexible, the pressure of the liquid 40 within the liquid container essentially corresponds to the pressure on a second surface 272 of the membrane 27 facing away from the liquid container.

The hydraulic actuator 80 of the illustrated embodiment example of a massage nozzle device 51a comprises a hollow element 82 in the form of a hollow cylinder with a diameter d₃ and a piston head 75, which can be pushed back and forth within the hollow cylinder along a longitudinal axis 511 between a first position (see FIG. 14(a)) and a second position (see FIG. 14(b)). The hollow element has two holding jaws 825 on the outside, which allow the hollow element 82 or the massage nozzle device to be held with pliers, for example.

The piston head 75 is formed at a first longitudinal end 721 on a nozzle tube 72 of the nozzle element 70. The nozzle tube 72 has an outer diameter d₂ and an inner diameter di, and is aligned with the longitudinal axis 511. The nozzle tube 72 protrudes at a second longitudinal end 824 of the hollow cylinder 82 out of a nozzle-side opening 821 of the hydraulic actuator 80. A head piece 74 is formed on the second longitudinal end 722 of the nozzle tube 72. The tube cavity 77 of the nozzle tube 72 opens into a nozzle outlet 73 in the center of the head piece 74.

The piston head 75 separates the inner volume of the hollow cylinder 82 into a first half-space 831 towards the first longitudinal end 823 of the hollow cylinder and into a second half-space 832 towards the second longitudinal end 823 of the hollow cylinder. A feed opening 85 is arranged at an upstream first longitudinal end 823 of the hollow cylinder 82, through which the pressurized liquid is conveyed into the first half-space 831 of the hollow cylinder 82. The liquid passes through the interior 77 of the nozzle tube to the pressurized nozzle outlet opening 73, where a directed jet 42 is formed, which continues to move in the identical but stationary liquid 40 due to the momentum of the liquid jet 42 until it finally strikes the first surface 271 of the membrane 27. In the process, the liquid jet is deflected 43, whereby a force Fm is exerted on the first surface of the membrane 27. This force pushes the elastic membrane 27 outwards in a locally limited area 273 in the direction of movement of the jet 42 and deforms it. Accordingly, the membrane 27 can transmit the force Fm to the outside in the deformed area 273. The liquid jet 42 thus acts as a mechanical actuator, which generates the desired massage effect.

Due to turbulence at the edge zone of the liquid jet 42, kinetic energy is lost as the liquid jet 42 passes through the stagnant liquid 40, which is converted into thermal energy. The resulting force Fm, which can be transferred to the membrane, is correspondingly lower. This can be compensated for by increasing the flow velocity of the liquid jet 42 at the nozzle outlet 73 by increasing the pressure in the liquid supply. However, this leads to a significant increase in the energy consumption of the pumping device.

A massage nozzle device 51a according to the invention can avoid this by minimizing the distance D between the nozzle outlet 27 and the membrane 27, and thus the energy loss of the liquid jet 42 moving in the liquid 40.

In the inactive operating state of the massage nozzle device 51a according to the invention, in which no fluid is pumped into the massage nozzle device 51a, the nozzle element 70 is fully retracted into hydraulic actuator 80 due to its own weight. The head piece 74 of the nozzle element 70 lies essentially flush against the second longitudinal end 824 of the hollow cylinder 82. The piston head 75 is in the first position, at the first longitudinal end 233 of the hollow cylinder.

At the beginning of the operational operating state, as shown in FIG. 14(a), liquid is pumped into the massage nozzle device 51a according to the invention, namely into the first half cavity 831 of the hollow cylinder 82. From there, the liquid continues to flow through the tube cavity 77 of the nozzle tube 72 to the nozzle outlet 73 due to the differential pressure Δp. Since the total area πd₃² of the cross-section of the piston head is larger than the cross-sectional area πd₁² of the tube cavity 77, this simultaneously results in a hydraulic force Fₖ, which acts along the longitudinal axis 511 in the direction of the second longitudinal end 824 of the hollow cylinder 82 on the piston head 75, and thus on the entire nozzle element 70. With a negligibly small cross-section of the tube cavity 77, with d₁²<<d₃², the pressure loss due to the liquid flowing out through the nozzle tube 72 is minimal, and the hydraulic force is Fₖ=Δp(d₃²−d(₁²)π/4. In practice, however, the actual resulting hydraulic force is somewhat lower, as this is not a static situation.

The hydraulic force acting on the piston head 75 pushes the nozzle element 70 out of the hollow cylinder 82 until the outlet opening 73 is in the vicinity of the membrane 27, as shown in FIG. 14(b). The force of the fluid jet 42 acting on the membrane 27 at a constant operating pressure of the massage nozzle device becomes substantially greater, as the momentum energy losses due to turbulence are reduced due to the substantially shorter path of the fluid jet 42 through the stagnant fluid 40. During extension, the volume in the first half-space 831 of the hollow cylinder increases and the volume in the second half-space 832 of the hollow cylinder decreases.

A second, maximum extended position of the nozzle element 70 is defined by a stopper 826 in the form of a projection of the hollow cylinder wall towards the longitudinal axis 511, against which the piston head 75 abuts in the second position.

However, this second, maximum extended position is only reached if a dynamic equilibrium is not reached beforehand, namely between the outwardly acting hydraulic force Fₖ on the piston head and a counteracting force on the head piece 74 of the nozzle element 70, which is generated by the fluid jet 43 deflected at the membrane 27. In FIG. 14(b), for example, such a dynamic equilibrium is present, which holds the nozzle element just before the second, maximum position.

If the massage nozzle device 51a is switched off by switching off the associated pressure pump, the hydraulic force Fₖ acting on the piston head drops to zero. The nozzle element 80 now automatically retracts into the hydraulic actuator 80 until the piston head 75 comes to rest against a stopper 827 at the first position, as shown in FIG. 14(a). The reset movement is only passively driven by the nozzle element's own weight. However, this passive restoring force requires a substantially vertical arrangement of the longitudinal axis 511.

Since the restoring force is countered by the buoyancy of the nozzle element 70 in the liquid 40, it can be advantageous for nozzle elements made of materials with a low specific density, such as plastic, if the nozzle element is weighted down with an additional weight. For example, a metal sleeve can be arranged around the nozzle tube, which increases the weight of the nozzle element and thus the restoring force due to gravity. In the embodiment example shown, the head piece 74 of the nozzle element 70 is designed as a flange in the form of a spherical segment. The shape of the head piece 74 is generally advantageously selected such that, on the one hand, damage to the mem-brane in the event of unintentional contact with the nozzle element is avoided and, on the other hand, the flow of the deflected liquid jet 43 is optimized.

In the embodiment example shown, the feed pipe 60 is designed as an elbow 61. It has a fastening element 64 with which the feed tube 60 can be fastened to another structure. In this way, the feed tube 60 also serves as a support platform for the massage nozzle device 51a according to the invention. The fastening element 64 is formed in one piece with the actual feed tube, and comprises a plurality of stiffening elements 642a, 642b, 642c, 642d, 642e, as well as a plurality of fastening points 641 in the form of through-holes.

The illustrated feed tube 60 has a hose fitting 62 at the upstream end, to which a fluid supply conduit in the form of an elastic hose is attached in a fluid-tight manner, for example by putting the hose over the hose connector 62 and fastening it with a hose clamp in a form-fitting and force-fitting manner. At the downstream end, the feed pipe has an externally threaded connection piece 63, which is screwed into a corresponding internal connection thread 84 of the hydraulic actuator 80.

Since the massage nozzle device 26 is located completely within the liquid 261 into which the nozzle element 70 emits the liquid jet 42 during operation, the absolute tightness of the fluidic connection between the feed pipe 60 and the hydraulic actuator 80 of the massage nozzle device 10′ is only of secondary importance. However, excessive losses reduce energy efficiency, as the pressure loss due to leaks must be compensated for by a corresponding increase in the operating pressure of the pumping device. It is therefore advantageous to use an additional sealant, such as an O-ring between the connection piece 63 and hydraulic actuator 80, or a Teflon tape wrap on the external thread of the connection piece 63, to ensure the tightest possible connection.

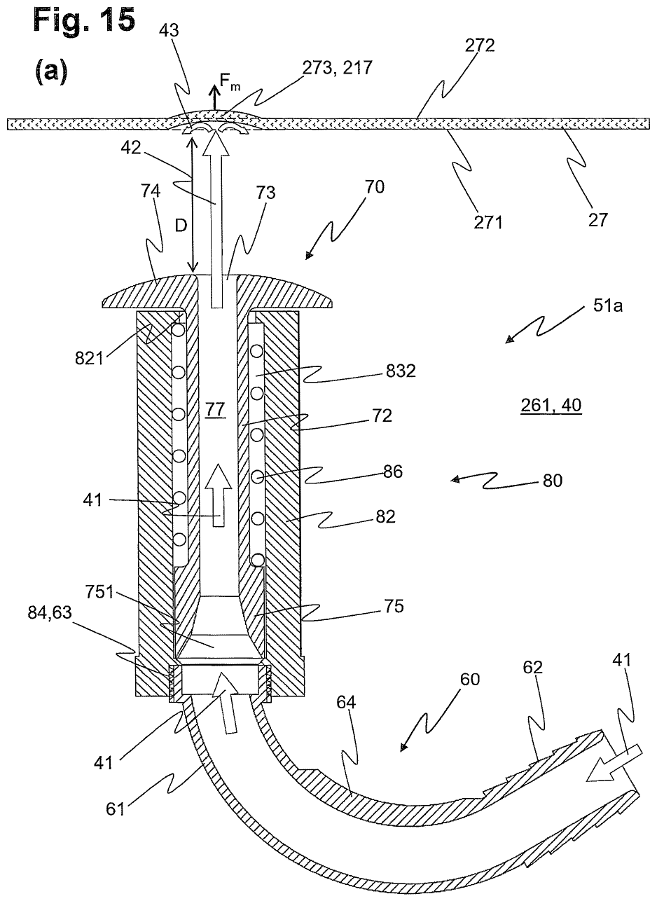

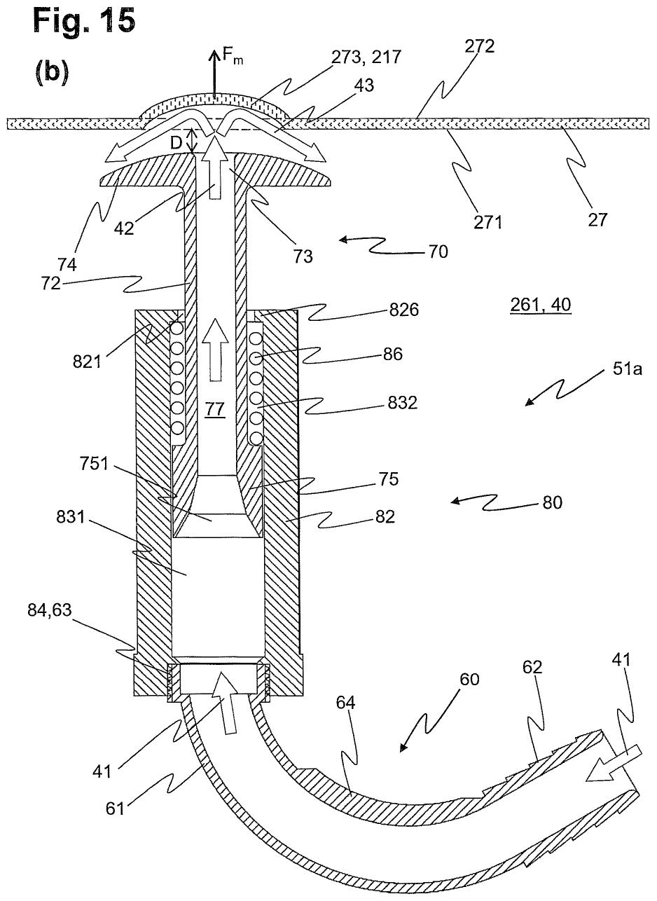

A further advantageous embodiment of a massage nozzle device 51a according to the invention is shown in FIG. 15. The external view of the massage nozzle device is identical to that shown in FIG. 13. The various components and the basic mode of operation of the massage nozzle device 51a correspond for the most part to the massage nozzle device of FIG. 15. Accordingly, only the additional features are discussed below.

The massage nozzle device 51a shown has a resetting element 86 in the form of a spiral compression spring. The resetting element is arranged within the second half space 832 of the hollow cylinder 82 between the stop element 826 and the upper end of the piston head 75. The nozzle tube 72 extends through the spiral compression spring 86.

The resetting element 86 serves to bring the nozzle element 70 back into the retracted position after the pressure pump is switched off, even without the resetting force due to the dead weight of the nozzle element 70, and thus independently of the orientation of the massage nozzle device 51a in space. Furthermore, the reset element is intended to support a dynamic movement of the nozzle element when the distance between the hydraulic actuator and the membrane changes, which will be discussed below.

In the fully retracted position of the nozzle element 70, as shown in FIG. 15(a), the spiral compression spring 86 is substantially relaxed. When the massage nozzle device is put into operation, the hydraulic force acting on the piston head moves the nozzle element 70 along the longitudinal axis in the direction of the second, extended position. This maximum extended position of the nozzle element is geometrically defined by the maximum compressed spiral compression spring. As soon as the nozzle outlet 73 reaches the membrane 27 and the stable equilibrium between the hydraulic force of the piston head and the opposing forces of the deflected liquid jet 43 and the restoring force of the restoring element 86 is established, the nozzle element 70 remains stationary as shown in FIG. 15(b).

The hydraulic force acting on the piston head 75 must overcome the increasing spring force of the compressed spiral compression spring 86 when the nozzle element 70 is extended. Advantageously, the spiral compression spring 86 is designed in such a way that even when the spiral compression spring is compressed to the maximum, the spring force is not greater than the hydraulic spring force at the intended operating pressure of the massage nozzle device 51a. Particularly advantageously, the spiral compression spring 86 has a spring constant that is just high enough to bring the nozzle element back into the retracted position.

The nozzle element 70 of the massage nozzle device 51a in FIG. 15 can be extended less than the nozzle element of the massage nozzle device in FIG. 14 with the same overall height. However, the massage nozzle device can be operated in any position and not only with the longitudinal axis parallel to the vertical. Such an embodiment of a massage nozzle device 51a is therefore particularly suitable for massage apparatus, for example in the form of a massage chair.

Furthermore, the massage nozzle device according to the invention can advantageously also be used together with the device shown in WO 2020/074046 A1. The mode of operation and structure of the solution there can be taken from the corresponding description. In this case, the water jets there are to be replaced by the massage nozzle devices here with their functional elements and the control provided here is also to be provided.

When using a massage nozzle device according to the invention to massage the body tissue of a user, the force acting locally through the membrane on the body surface is generally varied in time and/or space. A temporal change in the massage force can be achieved, for example, by changing the pump pressure over time. In turn, a spatial change in the massage point can be achieved by changing the position of the massage nozzle device.

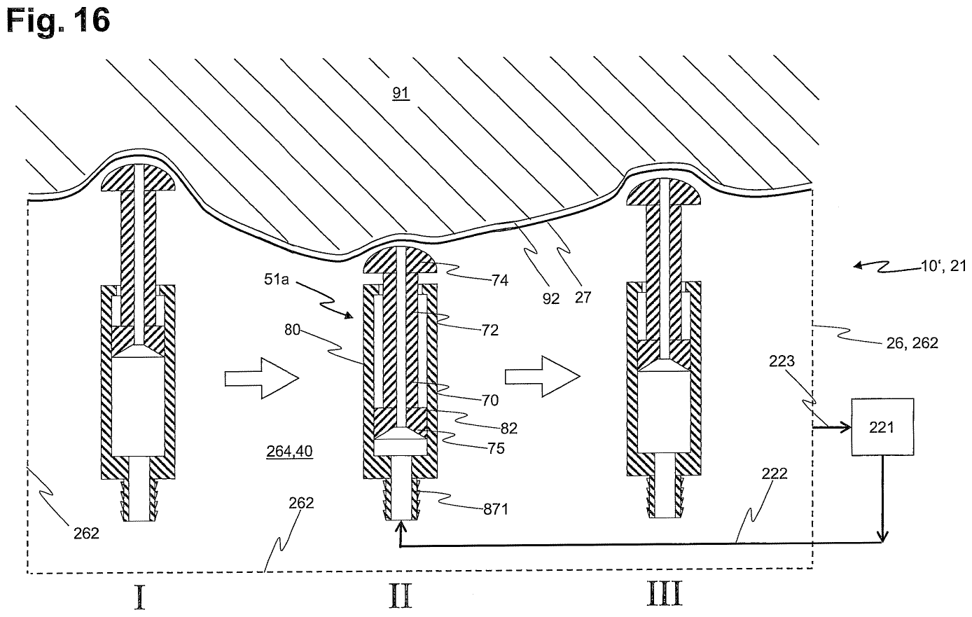

A massage apparatus 10′ according to the invention, in which a massage nozzle device 51a according to the invention is spatially displaced during operation in order to achieve a desired massage effect, is shown schematically in FIG. 16

The massage apparatus 10′ comprises a closed liquid container 26, consisting of schematically shown walls 262 and a flexible membrane 27. The body 91 of a user to be massaged is arranged on the upper outer side membrane 27. The schematic example shown can be understood as a massage table, in which the user lies on a flexible upper side of the liquid container 26. Similar to a waterbed, the membrane 27 adapts to the general shape of the user's body.

An embodiment of a massage nozzle device 51a according to the invention is arranged within the liquid container 261, which can be displaced horizontally using a suitable actuator device (not shown). Various solutions are known to the skilled person with which objects can be moved to different positions in a plane, for example with linear actuators mounted in a crossed manner.

A pump device 221 draws liquid 40 from the liquid container 261 via a supply conduit 223 and conveys it under pressure to the massage nozzle device 51a via a pressure conduit 222. The pressure conduit 222 is advantageously designed to be flexible, for example as an armored hose or metal hose, in order to be able to follow the moving massage nozzle device 51a.

The pumping device 221 can draw liquid directly from the liquid container 261, or from a reservoir, which in turn is filled from the liquid container 261. If several massage nozzle devices are present, these can be supplied via a common pumping device, or also via separate pumping devices.

As in the previous embodiments, the massage nozzle device 51a comprises a hydraulic actuator 80 with a hollow cylinder 82 and a piston head 75, on which the nozzle tube 72 of the nozzle element 70 is formed. A hemispherical head piece 74 is formed on the opposite longitudinal end of the nozzle tube 72, into which the nozzle tube 72 opens. The pressure conduit 222 (only shown schematically) is connected via a hose connector 871 formed on the hollow cylinder 82.

At position I on the left in FIG. 16, the nozzle element 70 is about three-quarters extended, the head piece 74 is close to the membrane 27. The liquid jet (not shown) directed at the membrane 27 deforms the membrane 27 locally outwards, towards the user's body 91, and exerts force locally on the body tissue.

If the massage nozzle device 51a is now moved transversely to position II, the nozzle element 70 follows the contour profile of the membrane 27, which in turn is given by the shape of the user's body. The nozzle tube 72 is pushed into the hollow cylinder 82 of the hydraulic actuator 2, while the head piece 74 maintains the relative distance to the mem-brane 27. In position II, the nozzle element 70 is then almost fully retracted.

If the massage nozzle device 51a is now moved further to position III, the nozzle element 70 again follows the contour of the body. The nozzle tube 72 moves out of the hydraulic cylinder 82, while the head piece 74 maintains the distance to the membrane 27.

An analogous dynamic adjustment takes place when the shape of the membrane changes, for example when the user moves. In such a case, the nozzle element 70 is pushed into the hydraulic actuator 80, or the nozzle element 70 is extended from the hydraulic actuator 80. Since the emerging fluid jet forms a fluid cushion between mem-brane 27 and head piece 74, the membrane cannot collide with the nozzle element even if the user makes jerky movements.

Advantageously, a massage nozzle device according to the invention is arranged in a massage apparatus according to the invention, taking into account the maximum extended position and the maximum retracted position of the nozzle element, in such a way that no collision of the membrane with the massage nozzle device is possible in the retracted position, and at the same time the nozzle element can always reach the maximum proximity to the membrane.

In order to achieve a lower overall height of a massage nozzle device according to the invention, the nozzle element of the massage nozzle device can be designed in several parts so that it can be extended in the manner of a telescope.

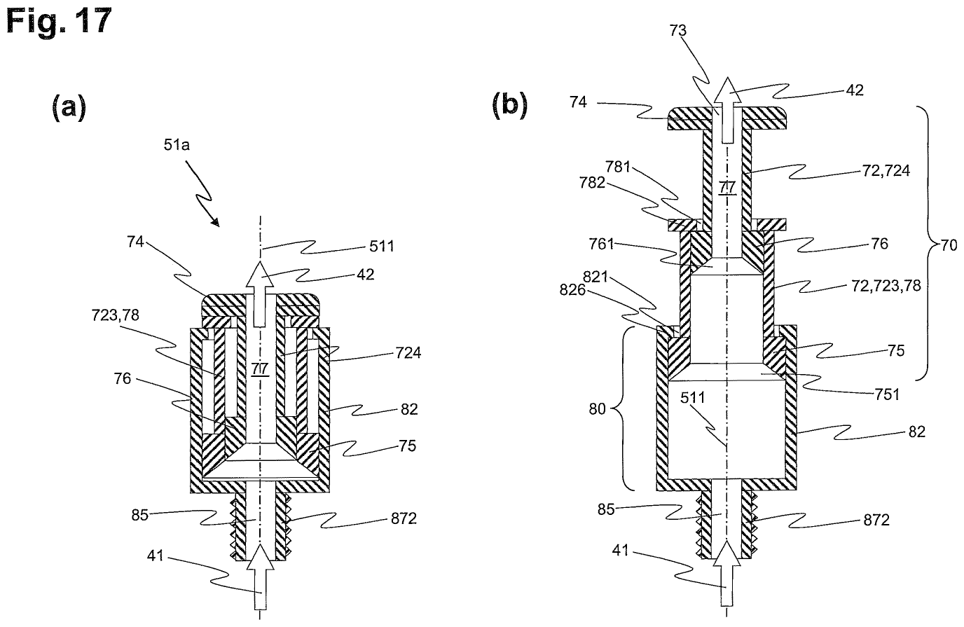

An example of such a variant of a massage nozzle device 51a according to the invention is shown in FIG. 17, with a nozzle tube 72 comprising two parts 723, 724. The mode of operation of the massage nozzle device corresponds in principle to the embodiments already discussed above.

The hydraulic actuator 80 comprises a first hollow cylinder 82 with a collar-shaped stop element 826 and an opening 821 for the nozzle tube at one longitudinal end, and a supply opening at the other longitudinal end. A hose connection 872 with an external thread allows easy connection of a conduit for supplying the pressurized fluid.

A first piston head 75 is arranged in the first hollow cylinder 82 so as to be displaceable along the longitudinal axis 511. A first part 723 of the nozzle tube 72, which is designed as a hollow cylinder 78, is formed on the first piston head 75. This second hollow cylinder 78 has a collar-shaped stop element 782 at the nozzle-side longitudinal end and an opening 781 for the second part of the nozzle tube 72.

A second piston head 76 is arranged in the second hollow cylinder 78 so as to be displaceable along the longitudinal axis 511. The second part 724 of the nozzle tube is formed on this second piston head 76. The head piece 74 of the nozzle element 70 is formed on the opposite longitudinal end of this second part 724 of the nozzle tube, in the form of a flat disk with rounded edges.

The first piston head 75 has an upstream central inlet opening 751 through which the flow of pressurized fluid 41 can flow from the first half cavity 831 of the first hollow cylinder 82 into the second hollow cylinder 78. Similarly, the second piston head 76 has a central inlet opening 761 upstream through which the flow of pressurized liquid 41 can flow from the second hollow cylinder 78 into the tube cavity 77 of the second part 724 of nozzle tube 72 before it finally emerges from the nozzle outlet 73 as a directed liquid jet 42.

In order to reduce energy losses due to turbulence within the massage nozzle device, the openings 751, 761 of the two piston heads 75, 76 are chamfered. This also ensures the accessibility of the hydraulically active piston head surface around the openings 751 and 162 when the massage nozzle device 51a is fully retracted, as shown in FIG. 17(a).

The maximum extended positions of the first part 723 and the second part 724 of the nozzle tube 72, as shown in FIG. 17(b), are determined by the stop elements 826 and 782, against which the nozzle-side upper end of the first piston head 75 and the second piston head 76 respectively abut.

On the other hand, as shown in FIG. 17(a), the maximum retracted positions of the first portion 723 and the second portion 724 of the nozzle tube 72 are defined by the abutment of the second stop member 782 on the upper surface of the first stop member 826, and by the abutment of the head portion 74 on the upper surface of the second stop member 782, respectively.

The return to the fully retracted state of the massage nozzle device 51a after the supply of the pressurized liquid has been stopped takes place passively, by the weight of the two parts 723, 724 of the nozzle tube 72 minus the buoyancy force in the liquid.

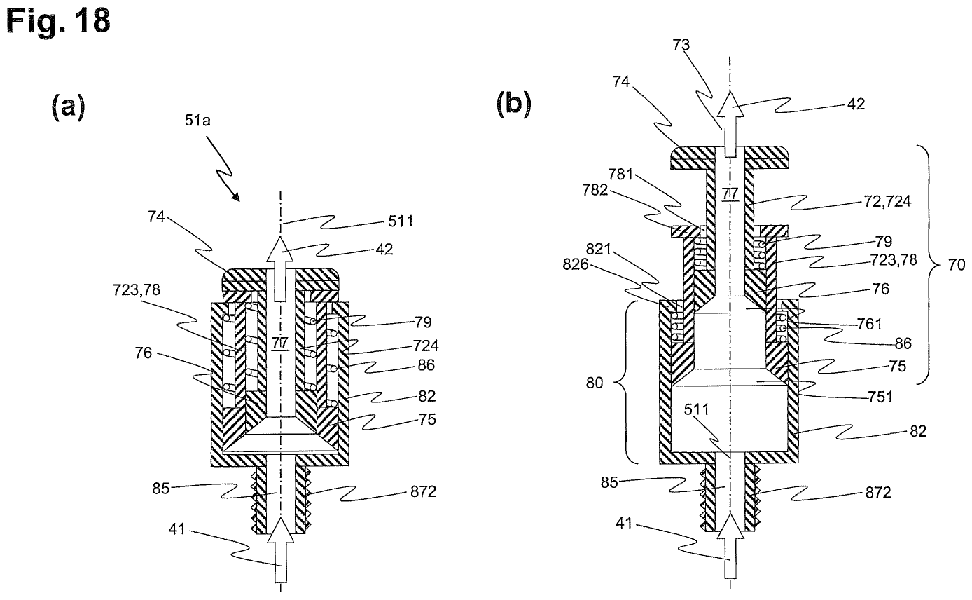

Reset elements can be used to support the return to the fully retracted state of the massage nozzle device and to ensure functionality even in an inclined orientation of the massage nozzle device. Such an embodiment example of a massage nozzle device 51a according to the invention is disclosed in FIG. 18. The individual components largely correspond to those from the previous embodiment example in FIG. 17. These will not be discussed again.

In the massage nozzle device 51a shown, a first resetting element 86 in the form of a spiral compression spring is arranged between the stop element 826 of the first hollow cylinder 82 and the upper side of the first piston head 75. A second return element 79 in the form of a spiral compression spring is arranged between the stop element 782 of the second hollow cylinder 78 and the upper side of the second piston head 76.

The spring constants of the two spiral compression springs 86, 79 can be selected to be similar or identical. Alternatively, spiral compression springs of different strengths can be used to control the movements of the individual components 72, 78, 82 during retraction and extension in a precisely defined manner.

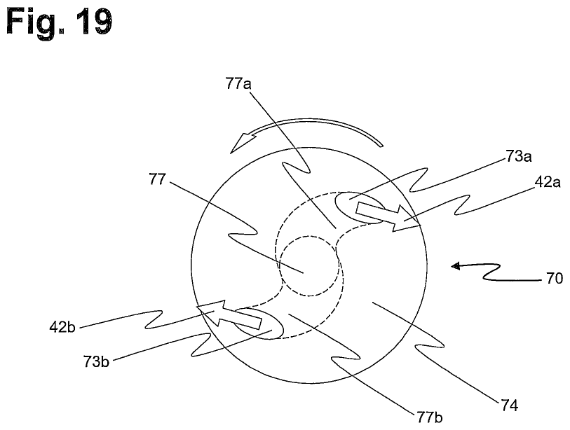

Instead of a single liquid jet directed perpendicular to the membrane, it can be advantageous to generate a plurality of obliquely directed, moving jets of liquid with a massage nozzle device according to the invention, so that a rapidly moving force effect is created in the active massage area of the nozzle element. Such a massage nozzle device according to the invention can be realized, for example, with the head piece 74 of the nozzle element 70 in FIG. 19. Instead of a central nozzle outlet opening, the head piece 74 has two nozzle outlet openings 73a, 73b arranged rotationally symmetrically to the longitudinal axis. For this purpose, the tube cavity 77 of the nozzle tube splits into two tube manifolds 77a, 77b, which open into the nozzle outlet openings 73a, 73b. The nozzle outlet openings 73a, 73b and tube manifolds 77a, 77b are designed in such a way that the liquid flow in the nozzle tube is separated with as little turbulence as possible and directed to the outlet openings, where two rotationally symmetrical liquid jets 42a, 42b are formed, which are aligned at an acute angle to the longitudinal axis of the nozzle tube.

The deflection of the liquid jets in the head piece 74 creates a rotational force which causes the nozzle tube with the head piece 74 to rotate about the longitudinal axis. As a result, the two water jets 42a, 42b also move around the longitudinal axis, or two force points on the membrane move along circular paths.

Instead of making the entire nozzle tube rotatable, the head piece can be rotatably mounted on the nozzle tube. This avoids sliding friction between the piston head and the hollow cylinder.

Instead of two outlet openings 73a, 73b, three or more outlet openings can also be provided.

The present invention is not limited in its scope to the specific embodiments described herein. Rather, in addition to the examples disclosed herein, various further modifications of the present invention, which also fall within the scope of protection of the claims, will be apparent to those skilled in the art from the description and the accompanying figures. In addition, various references are cited in the description, the disclosure of which is hereby incorporated by reference into the description in its entirety.

### List of Reference Numerals

10, 10′ massage apparatus
11 chair
111 headrest
112 backrest
113 seat
114 leg support
115 flexible layer
121 support frame
122 pivot axis
123, 123′ frame
21, 21′ massage module
214 supply conduit
217 massage working area
22 pump module
221 pump
222, 222′ feed conduit, pressure conduit
223 drain conduit, pump supply conduit
224, 224a liquid reservoir
225 inlet opening of the drain conduit
23 control module
230 control unit
231 control line to the pumping device
232 control line to the hydraulic actuator
233 control line to the nozzle element
24 drive module
241a first servomotor
241b second servomotor
242a first threaded spindle
242b second threaded spindle
243a first running rails
243b second running rails
244a first support plate
244b second support plate
244c third support plate
251 padding element
252 opening
253 structuring element
254 fluid connections
255 end of the pressure conduit
26 liquid container
261 internal space of the container, closed internal volume
262 rigid wall
263 rigid cover
27 flexible membrane
271 first surface of the membrane
272 second surface of the membrane
273 deformed area of the membrane
274 meeting point
40 liquid
41 pressurized liquid
42, 42a, 42b directed liquid jet
43 deflected liquid jet
51, 51a massage nozzle device
511 longitudinal axis
60 feed pipe
61 elbow
62 hose connector
63 connection thread, male thread
64 fastening element
641 screw holes
642a-642e stiffening elements
70 nozzle element
72 nozzle tube
721 first longitudinal end of the nozzle tube
722 second longitudinal end of the nozzle tube
723 first part of the nozzle tube
724 second part of the nozzle tube
73 nozzle outlet opening
73a, 73b nozzle outlet opening
74 nozzle head piece
75th piston head
751 Inlet opening
76 second piston head
761 inlet opening
77 tube cavity
77a, 77b Pipe branching
78 second hollow cylinder
781 nozzle-side opening of the second hollow cylinder
782 stop element
79 second reset element, compression spring
80 hydraulic actuator
82 first hollow cylinder
821 nozzle-side opening of the hollow cylinder
823 first longitudinal end of the hollow cylinder
824 second longitudinal end of the hollow cylinder
825 holding jaw
826 stop element at the second position of the piston head
827 stop element at the first position of the piston head
831 first cylinder half space
832 second cylinder half space
84 connection thread, female thread
85 supply opening
86 first reset element, compression spring
871 hose connector
872 hose connection with external thread
91 user, body of the user
92 body surface of the user
d₁ inner diameter of the nozzle tube
d₂ outer diameter of the nozzle tube
d₃ inner diameter of the hollow cylinder
D distance between nozzle outlet and membrane
Fₘ force effect of the massage area, through membrane acting force outwards
Fₖ hydraulic force acting on the piston head
Δp pressure difference between the pump pressure of the supplied liquid and the static pressure in the liquid container
x, y direction of movement of the massage module
P movement path of the massage module

1. A massage apparatus for dry hydromassage, comprising:
a basic structure; and
a massage module with
a substantially closed container with a wall;
a flexible membrane forming part of the wall of the closed container, having a first surface towards the interior of the closed container; and
at least one massage nozzle device, which is set up to direct a liquid jet inside the closed container onto the first surface of the flexible membrane;
characterized by a drive module which is set up to move the massage module in relation to the basic structure in at least one direction of movement (x, y).

2. The massage apparatus according to claim 1, wherein on the side of the flexible membrane of the massage module facing away from the container a flexible layer is provided, which is fixedly mounted with respect to the basic structure of the massage apparatus.

3. The massage apparatus according to claim 1, wherein the closed container of the massage module is filled or is fillable with a liquid.

4. The massage apparatus according to claim 1, wherein the flexible membrane and a rigid cover together form a flat wall of the container of the massage module.

5. The massage apparatus according to claim 1, comprising a pump module for supplying the at least one massage nozzle device of the massage module with pressurized liquid.

6. The massage apparatus according to claim 4, with a pump module for supplying the at least one massage nozzle device of the massage module with pressurized liquid, comprising a pump and a drain conduit which fluidically connects the container of the massage module and a pump inlet of the pump to one another; wherein an inlet opening of the drain conduit is arranged in a wall of the container which is adjacent to the rigid cover.

7. The massage apparatus according to claim 1, with a control module which is set up to control the drive module and/or the massage module.

8. The massage apparatus according to claim 1, wherein the drive module is arranged to move the massage module in a plane (x, y).

9. The massage apparatus according to claim 1, wherein the drive module is arranged to move the massage module along a curved path (P) in space.

10. The massage apparatus according to claim 1, wherein the drive module is arranged to rotate the massage module about an axis in space.

11. The massage apparatus according to claim 1, wherein the flexible membrane of the massage module comprises at least one structuring feature arranged to adjust the mechanical properties of the flexible membrane.

12. The massage apparatus according to claim 11, wherein the at least one structuring element is molded or glued onto the flexible membrane of the massage module so that the flexible membrane is locally stiffened.

13-53: (canceled)

54. A massage apparatus according to claim 1, wherein the at least one massage nozzle device is a massage nozzle device for generating a directed liquid jet, comprising
a nozzle element having a nozzle tube for producing a directed liquid jet, the nozzle tube having an inlet opening at a first longitudinal end and an outlet opening at a second longitudinal end; and
a hydraulic actuator which is operatively connected to the nozzle element and which is set up in such a way that it can effect a displacement of the nozzle element along a longitudinal axis of the nozzle tube from a retracted position to an extended position.

55. The massage apparatus according to claim 54, the at least one massage nozzle device having a feed conduit for supplying the nozzle element with pressurized liquid for generating the directed liquid jet, wherein the feed conduit is arranged to also supply the hydraulic actuator with pressurized liquid for operating the hydraulic actuator.

56. The massage apparatus according to claim 54, the at least one massage nozzle device comprising
a hydraulic actuator with a first hollow cylinder and a first piston head, which is arranged in the first hollow cylinder and is displaceable along the longitudinal axis between a retracted position and an extended position;
wherein the nozzle tube is operatively connected to the first piston head in such a way that a displacement of the first piston head along the longitudinal axis causes a displacement of the nozzle tube along the longitudinal axis; and
wherein the first hollow cylinder has an opening at a longitudinal end, through which the nozzle tube of the nozzle element extends.

57. The massage apparatus according to claim 56, wherein in the at least one massage nozzle device, the inlet opening of the nozzle tube is arranged in the first piston head.

58. The massage apparatus according to claim 56, wherein in the at least one massage nozzle device, the hydraulic actuator comprises a first reset element, which applies a force along the longitudinal axis to the first piston head in the direction of the retracted position in the first hollow cylinder.

59. The massage apparatus according to claim 56, wherein in the at least one massage nozzle device, the nozzle tube is connected to or molded onto the first piston head.

60. The massage apparatus according to claim 56,
wherein in the at least one massage nozzle device, the nozzle tube is designed in two parts, having a first part which is connected to or molded onto the first piston head, and with a second part, which is connected to the first part in a fluid-tight manner, and on which the outlet opening is arranged;
wherein the second part of the nozzle tube is connected to or molded onto a second piston head;
wherein the first part of the nozzle tube comprises a second hollow cylinder, in which the second piston head of the second part of the nozzle tube is arranged and is displaceable back and forth along the longitudinal axis between a retracted position and an extended position; and
wherein this second hollow cylinder has an opening at a longitudinal end opposite the first piston head, through which the second part of the nozzle tube extends.

61. The massage apparatus according to claim 60, wherein in the at least one massage nozzle device, the nozzle element comprises a second reset element, which applies a force to the second piston head of the second part of the nozzle tube along the longitudinal axis in the direction of the retracted position in the second hollow cylinder of the first part of the nozzle tube.

62. The massage apparatus according to claim 54, wherein in the at least one massage nozzle device, the nozzle element comprises a head piece at the second longitudinal end of the nozzle tube, on which head piece an outlet opening of the nozzle element is arranged.

63. The massage apparatus according to claim 62, wherein in the at least one massage nozzle device, at the second longitudinal end of the nozzle tube the head piece projects transversely to the longitudinal axis over the nozzle tube.

64. The massage apparatus according to claim 62, wherein in the at least one massage nozzle device, the head piece of the nozzle element is mounted rotatably about the longitudinal axis, and wherein the head piece has one or more outlet openings which are designed such that liquid jets emerging from said outlet openings exert a rotational force on the head piece, which causes the head piece to rotate about the longitudinal axis.
